(19) United States
(12) Patent Application Publication
(10) Pub. No.: US 2022/0366451 A1
(43) Pub. Date: Nov. 17, 2022

(54) DISPLAY APPARATUS, EVENT SUPPORT SYSTEM, DISPLAY METHOD, AND EVENT SUPPORT SYSTEM PRODUCTION METHOD

(71) Applicant: NEC Solution Innovators, Ltd., Koto-ku, Tokyo (JP)

(72) Inventors: Wataru SAKUMA, Tokyo (JP); Kohei KANAZAWA, Tokyo (JP); Yutaka MORIKAWA, Tokyo (JP); Hikaru NONAKA, Tokyo (JP); Masahito TAKAHASHI, Tokyo (JP); Takamitsu WATANABE, Tokyo (JP); Keisuke SUMIDA, Tokyo (JP); Yohei MIZUTANI, Tokyo (JP); Yuya KIMOTO, Tokyo (JP)

(73) Assignee: NEC Solution Innovators, Ltd., Koto-ku, Tokyo (JP)

(21) Appl. No.: 17/771,074

(22) PCT Filed: Oct. 15, 2020
(86) PCT No.: PCT/JP2020/038996

§ 371 Date: Apr. 22, 2022

(30) Foreign Application Priority Data
Oct. 25, 2019 (JP) 2019-194795

(51) Int. Cl. G06Q 30/02; G06T 11/60; G06F 40/40; G01C 21/36

(52) U.S. Cl. CPC G06Q 30/0261; G06T 11/60; G06F 40/40; G06Q 30/0271; G01C 21/3626

(57) ABSTRACT

In a display apparatus, an acquisition unit acquires coordinate information associated with a fiducial marker installed in a specific area of a real space and a virtual object including advertisement information, an imaging unit images a real image and the fiducial marker, a self-position specifying unit specifies a self-position from a distance and an angle from the imaged fiducial marker, a state detecting unit detects a distance and an angle of view from the virtual point based on the self-position, a selection unit selects any virtual object existing within an angle of view from the self-position, and a display unit displays a main object of the virtual object existing within the angle of view from the self-position in such a manner that the main object is superimposed on a relative position on the real image and displays a main object and a sub object of the selected virtual object.

### TECHNICAL FIELD

The present invention relates to a display apparatus, an event support system, a display method, and an event support system production method.

### BACKGROUND ART

Recently, a technique for promoting products and the like using an augmented reality (AR) has been proposed (for example, Patent Literature 1).

### CITATION LIST

### Patent Literature

Patent Literature 1: JP2018-147137 A

### SUMMARY OF INVENTION

### Technical Problem

However, in the conventional technique, as the number of products and the like to be promoted increases, it is necessary to prepare a large number of markers, which is costly and laborious.

With the foregoing in mind, it is an object of the present invention to provide a low-cost and easy-to-use display apparatus, an event support system, a display method, and an event support system production method.

### Solution to Problem

In order to achieve the above object, the present invention provides a display apparatus, including:

a storage unit;

an acquisition unit;

an imaging unit,

a self-position specifying unit;

a state detecting unit;

a selection unit; and

a display unit, wherein

the acquisition unit acquires coordinate information associated with a fiducial marker installed in a specific area of a real space and a virtual object including advertisement information,

a virtual point indicating a specific position in the specific area is mapped on the coordinate information,

the advertisement information is information on at least one of an advertising target product or an advertising target service,

the virtual object is associated with the virtual point and composed of a main object and a sub object,

the main object is an image object representing contents of the advertisement information,

the sub object is an object to which text information representing the contents of the advertisement information is added,

the storage unit stores the acquired coordinate information and virtual object, the imaging unit images a real image and the fiducial marker,

the self-position specifying unit specifies a self-position from a distance and an angle from the imaged fiducial marker,

the state detecting unit detects a distance and an angle of view from the virtual point based on the self-position,

the selection unit selects any virtual object existing within an angle of view from the self-position, and

the display unit displays a main object of the virtual object existing within the angle of view from the self-position in such a manner that the main object is superimposed on a relative position on the real image and displays a main object and a sub object of the selected virtual object.

The present invention also provides an event support system, including:

the display apparatus according to the present invention;

a demand level calculation apparatus;

an advertisement information generation apparatus; and

an information sharing apparatus, wherein

the demand level calculation apparatus calculates a magnitude of the demand level for the advertisement information based on the advertisement information and the user information,

the advertisement information generation apparatus generates the advertisement information and the virtual object,

the information sharing apparatus administrates information sharing among three terminals of a visitor, an organizer, and an exhibitor,

the visitor's terminal is the display apparatus,

the organizer's terminal is the demand level calculation apparatus,

the exhibitor's terminal is the advertisement information generation apparatus, and

the information sharing apparatus can connect the display apparatus, the demand level calculation apparatus, and the advertisement information generation apparatus via a communication network.

The present invention also provides a display method, including the steps of:

storing;

acquiring;

imaging;

self-position specifying;

state detecting;

selecting; and

displaying, wherein

the acquiring acquires coordinate information associated with a fiducial marker installed in a specific area of a real space and a virtual object including advertisement information,

a virtual point indicating a specific position in the specific area is mapped on the coordinate information,

the advertisement information is information on at least one of an advertising target product or an advertising target service,

the virtual object is associated with the virtual point and composed of a main object and a sub object,

the main object is an image object representing contents of the advertisement information,

the sub object is an object to which text information representing the contents of the advertisement information is added,

the storing stores the acquired coordinate information and virtual object, the imaging images a real image and the fiducial marker,

the self-position specifying specifies a self-position from a distance and an angle from the imaged fiducial marker,

the state detecting detects a distance and an angle of view from the virtual point based on the self-position,

the selecting selects any virtual object existing within an angle of view from the self-position, and

the displaying displays a main object of the virtual object existing within the angle of view from the self-position in such a manner that the main object is superimposed on a relative position on the real image and displays a main object and a sub object of the selected virtual object.

The present invention also provides an event support system production method, including:

the display apparatus according to the present invention;

a demand level calculation apparatus;

an advertisement information generation apparatus; and

an information sharing apparatus, wherein

the demand level calculation apparatus calculates a magnitude of the demand level for the advertisement information based on the advertisement information and the user information,

the advertisement information generation apparatus generates the advertisement information and the virtual object,

the information sharing apparatus administrates information sharing among three terminals of a visitor, an organizer, and an exhibitor,

the visitor's terminal is the display apparatus,

the organizer's terminal is the demand level calculation apparatus,

the exhibitor's terminal is the advertisement information generation apparatus, and the information sharing apparatus can connect the display apparatus, the demand level calculation apparatus, and the advertisement information generation apparatus via a communication network.

### Advantageous Effects of Invention

According to the present invention, it is possible to promote products and the like at low cost and easily.

### BRIEF DESCRIPTION OF DRAWINGS

FIG. 1 is a block diagram showing the configuration of an example of an apparatus according to the first example embodiment.

FIG. 2 is a block diagram showing an example of the hardware configuration of the apparatus according to the first example embodiment.

FIG. 3 is a schematic diagram showing an example of coordinate information.

FIG. 4 is a schematic diagram showing an example of displaying a virtual object on a display screen of a terminal in the first example embodiment.

FIG. 5 is a schematic diagram showing an example of a display screen for displaying a route in the first example embodiment.

FIG. 6 is a flowchart showing an example of the processing in the apparatus according to the first example embodiment.

FIG. 7 is a block diagram showing the configuration of an example of an apparatus according to the second example embodiment.

FIG. 8 is a block diagram showing an example of the hardware configuration of the apparatus according to the second example embodiment.

FIG. 9 is a flowchart showing an example of the processing in the apparatus according to the second example embodiment.

FIG. 10 is a schematic diagram showing an example of calculated demand level data in the apparatus according to the second example embodiment.

FIG. 11 is a block diagram showing the configuration of an example of an apparatus according to the third example embodiment.

FIG. 12 is a block diagram showing an example of the hardware configuration of the apparatus according to the third example embodiment.

FIG. 13 is a flowchart showing an example of the processing in the apparatus according to the third example embodiment.

FIG. 14 is a block diagram showing the configuration of an example of an apparatus according to the fourth example embodiment.

FIG. 15 is a block diagram showing an example of the hardware configuration of the apparatus according to the fourth example embodiment.

FIG. 16 is a flowchart showing an example of the processing in the apparatus according to the fourth example embodiment.

FIG. 17 is a schematic diagram showing the configuration of an example of a system according to the fifth example embodiment.

FIGS. 18A and 18B are schematic diagrams showing an example of switching the display of a sub object.

### DESCRIPTION OF EXAMPLE EMBODIMENTS

Example embodiments of the present invention will be described with reference to the drawings. Note here that the present invention is not limited to the following example embodiments. In the drawings, identical parts are indicated with identical reference signs. Each example embodiment can be described with reference to the descriptions of other example embodiments, unless otherwise specified, and the configurations of the example embodiments may be combined, unless otherwise specified.

### First Example Embodiment

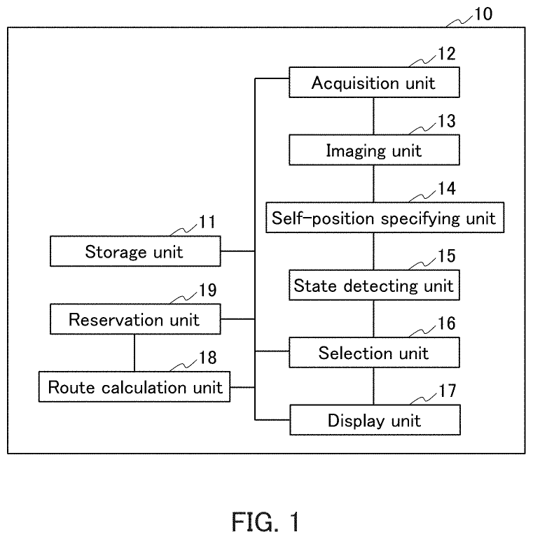

FIG. 1 is a block diagram showing the configuration of an example of the display apparatus 10 according to the present example embodiment. As shown in FIG. 1, the apparatus 10 includes a storage unit 11, an acquisition unit 12, an imaging unit 13, a self-position specifying unit 14, a state detecting unit 15, a selection unit 16, and a display unit 17. As will be described below, the apparatus 10 may further include a route calculation unit 18, a reservation unit 19, an input unit (not shown), an extraction unit (not shown), a recommendation unit (not shown), a translation unit (not shown), and the like.

The apparatus 10 may be, for example, a single apparatus including the above-described components, or may be an apparatus to which the components are connectable via a communication network. The communication network is not particularly limited, and a known network can be used, and may be, for example, a wired network or a wireless network. Examples of the communication network include an Internet line, a world wide web (WWW), a telephone line, a local area network (LAN), a storage area network (SAN), and a delay tolerant networking (DTN). Examples of the wireless communication include wireless fidelity (WiFi) and Bluetooth®. The wireless communication may be direct communication (Ad Hoc communication) or indirect communication via access points. The apparatus 10 may be incorporated in a server as a system, for example. The apparatus 10 may be, for example, a personal computer (PC, e.g., desktop PC, notebook PC) or a visitor's terminal (e.g., a smartphone, a mobile phone, a wearable terminal such as a spectacle type, a wristwatch type, or the like) to be described below, in which the program of the present invention is installed. The visitor's terminal can be used, for example, in or out of the specific area and for any period of time.

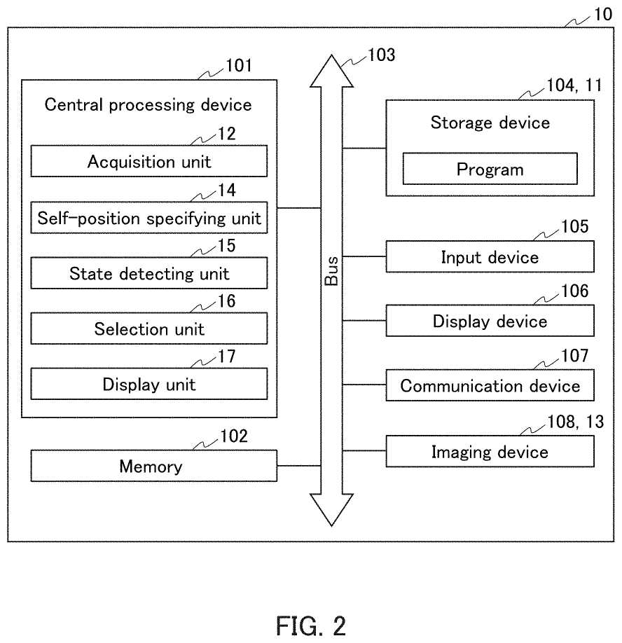

FIG. 2 shows a block diagram of the hardware configuration of the apparatus 10. The apparatus 10 includes, for example, a central processing device (CPU, GPU, etc.) 101, a memory 102, a bus 103, a storage device 104, an input device 105, a display device (display) 106, a communication device 107, an imaging device 108, and the like. The respective components of the hardware of the apparatus 10 are connected with one another via the bus 103 through respective interfaces (I/F).

The central processing device 101 is responsible for the overall control of the apparatus 10. In the apparatus 10, the central processing device 101 executes, for example, the program of the present invention and other programs, and reads and writes various types of information. Specifically, for example, the central processing device 101 functions as an acquisition unit 12, a self-position specifying unit 14, a state detecting unit 15, a selection unit 16, and a display unit 17. The central processing device 101 may further function as, for example, a route calculation unit 18, a reservation unit 19, an extraction unit (not shown), a recommendation unit (not shown), a translation unit (not shown), or the like.

The bus 103 can also be connected to an external device, for example. Examples of the external device include external storage devices (such as an external databases) and printers. The apparatus 10 can be connected to an external network (communication network) by a communication device 107 connected to the bus 103 and can be connected to other devices or equipment via an external network, for example. Examples of the other device include administrator's terminals (PCs, servers, smartphones, tablets, etc.).

The apparatus 10 further includes an input device 105 and a display device 106, for example. Examples of the input device 105 include a touch panel, a keyboard, and a mouse. The input device 105 may function as the input unit, for example. Examples of the display device 106 include an LED display and a liquid crystal display. The imaging device 108 is, for example, a 2D camera, a 3D camera, or the like, and functions as an imaging unit 13.

In the apparatus 10, for example, the acquisition unit 12 may acquire coordinate information and a virtual object, which will be described below, using the input device 105. Further, the acquisition unit 12 may acquire the coordinate information and the virtual object via a communication network by, for example, the communication device 107. The communication network is, for example, the same as described above.

The memory 102 includes, for example, a main memory, and the main memory is also referred to as a main storage device. When the central processing device 101 performs processing, the memory 102 reads various kinds of operation programs such as the program of the present invention stored in a storage device 107 to be described below, and the central processing device 101 receives data from the memory 102 and executes the program. The main memory is, for example, a random access memory (RAM). The memory 102 further includes, for example, a read-only memory (ROM), a cache memory, and the like.

The storage device 104 is also referred to as a so-called auxiliary storage device with respect to the main memory (main memory device), for example. As described above, the storage device 104 stores the operation program including the program of the present invention. The storage device 104 includes, for example, a recording medium and a drive for reading from and writing to the recording medium. The recording medium is not particularly limited, and may be, for example, a built-in type or an external type, and examples thereof include a hard disk (HD), a floppy® disk (FD), a CD-ROM, a CD-R, a CD-RW, an MO, a DVD, a flash memory, and a memory card. The drive is not particularly limited. The storage device 104 may be, for example, a hard disk drive (HDD) in which the recording medium and the drive are integrated.

In the apparatus 10, the memory 102 and the storage device 104 may also store access information and log information from the administrator and information acquired from an external database (not shown). The storage unit 11 can use, for example, the memory 102 and the storage device 104.

The acquisition unit 11 acquires coordinate information associated with a fiducial marker installed in a specific area of a real space and a virtual object including advertisement information. The specific area is not particularly limited, and examples thereof include large-scale events such as trade fairs, exhibitions, and expositions; short term events such as events at department stores, buildings of facilities such as museums and art museums; and venues and sites such as shopping malls and the like (hereinafter, also referred to as events and the like). Examples of the large-scale event include expos such as career expos and career-change expos; music festivals; and comic markets. While the specific area will be described below with reference to the venue of a trade fair as an example, the present invention is not limited thereto.

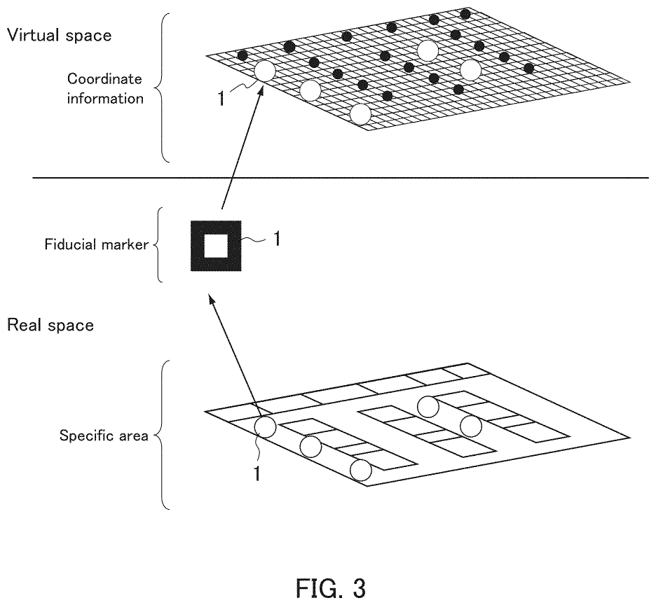

FIG. 3 shows an example of the coordinate information. The coordinate information is information indicating the specific area with coordinates. In the specific area, for example, fiducial markers 1 are installed at regular intervals (for example, at intervals of 15 m or the like). The fiducial marker 1 is not particularly limited, and is, for example, an AR marker or the like. The fiducial marker 1 is a marker for specifying a self-position in the specific area as described below. Therefore, when a plurality of fiducial markers 1 are installed in the specific area, for example, the fiducial markers 1 are preferably different from one another. The number of the fiducial markers 1 is not particularly limited, and may be one or two or more. In FIG. 3, five fiducial markers 1 are arranged in the specific area (white circles). The installation location of the fiducial marker 1 is not particularly limited, and may be, for example, a floor, a wall, or a ceiling, or the fiducial marker 1 may be installed by hanging a panel equipped with the reference marker 1 from the ceiling in the air. Virtual points indicating specific positions in the specific area are mapped on the coordinate information. In FIG. 3, the virtual points are indicated by black circles. The specific position indicates, for example, the position of each booth of the exhibitor in an event or the like. While the specific position is also referred to as a booth, the specific position is not limited thereto, and may be, for example, a position of each store in a shopping mall, a display position of each display article in a museum, or the like.

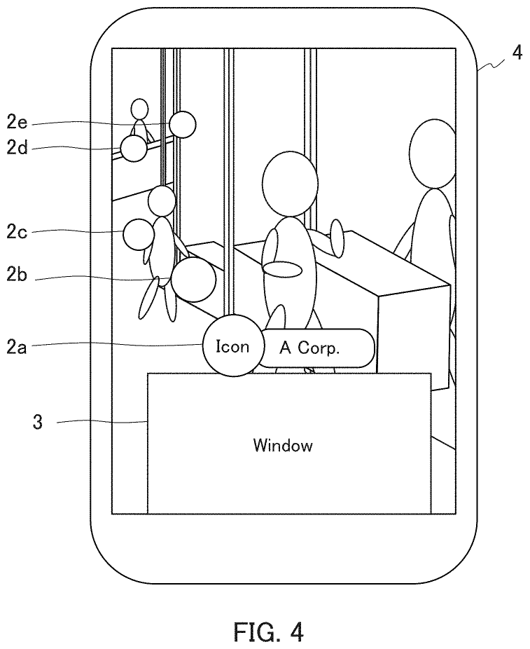

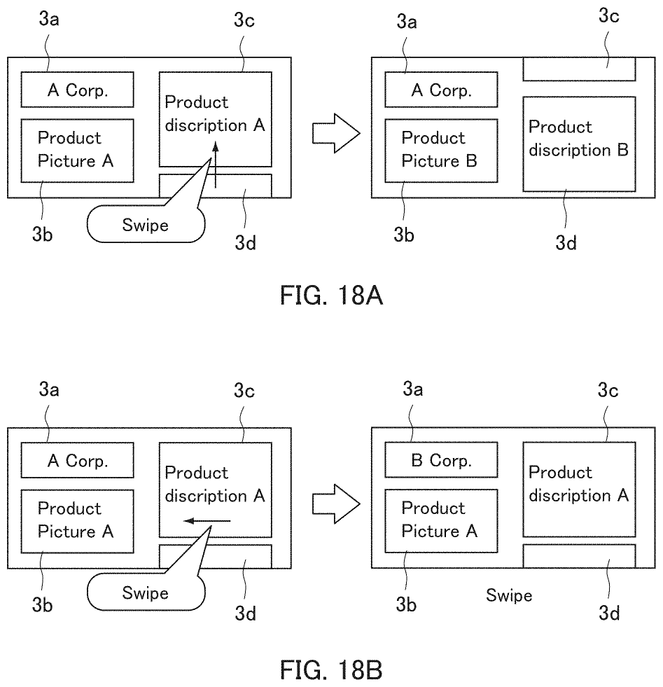

The advertisement information is information on at least one of an advertising target product and an advertising target service (hereinafter, also referred to as an advertising target product or the like). The advertising target product or the like is not particularly limited. The virtual object is associated with the virtual point. That is, the virtual object is associated with each booth of the exhibitor or the like at the specific position. FIG. 4 shows an example of displaying the virtual object on the display screen of the terminal 4. In FIG. 4, the apparatus 10 is the visitor's terminal 4 to which the program of the present invention is installed. The virtual object is composed of main objects 2 (2a to 2e) and a sub object 3. The main objects 2 are image objects (also called icons) representing contents of the advertisement information. The sub object 3 is an object (also called a window) to which text information representing the contents of the advertisement information is added. The number of main objects 2 is not particularly limited, and is preferably one for one of the virtual points, for example. While the shape of the main object 2 is a circle in FIG. 4, the present invention is not limited thereto. The icon may be, for example, an image obtained by imaging the advertising target product or the like itself, or may be an image in which a mark or a company name of a company or the like (exhibitor or the like) providing the advertising target product or the like is described. The number of sub objects 3 is not particularly limited, and may be one or two or more. While the shape of the sub object 3 is a quadrangle in FIG. 4, the present invention is not limited thereto. The window shows, for example, detailed information of the advertising target product (for example, the name, size, price, usage, and the like of the advertising target product or the like). In the case where there are a plurality of advertising target products, for example, the sub object 3 may be divided into a plurality of blocks, and each of the blocks may show information of the advertising target product or the like. Specifically, for example, as shown in FIGS. 18A and 18B, the name of the company or the like providing the advertising target product or the like is displayed in the block 3a, the photograph of the product A, which is the first advertising target product or the like, is displayed in the block 3b, and the text information (also referred to as detailed information) relating to the product A is displayed in the block 3c. In FIG. 18A, when it is desired to display the product B, which is the second advertising target product or the like, for example, a photograph of the product B is displayed in the block 3b and text information of the product B is displayed in the block 3c by performing operations such as scrolling and swiping in the vertical direction on the screen. On the other hand, as shown in FIG. 18B, for example, the sub object 3 corresponding to the booth (virtual point) of the company “B Corp.” existing in the vicinity of the booth (virtual point) of the company “A Corp.” may be displayed by performing operations such as scrolling and swiping in the left-right direction on the screen. Note that FIGS. 18A and 18B are merely illustrative and do not limit the present invention.

For example, the acquisition unit 12 may further acquire user information including attribute information and behavior information. The user information is information of a user (also referred to as a visitor) of the apparatus 10 (terminal 4), and examples of the attribute information include items such as a profession, a post, and a business scale. Examples of the behavior information include operation logs such as the number of taps of the icon, a tap history, a browsing history of the window, a browsing count, and a browsing history. For example, when the visitor uses the apparatus 10 (or the program of the present invention) for the first time, the acquisition unit 12 acquires the attribute information using the input device 105, the communication device 107, or the like. On the other hand, when the visitor has used the apparatus 10 (or the program of the present invention) before, the acquisition unit 12 may acquire the attribute information stored in the storage unit 11, for example.

The acquisition unit 12 may further acquire additional information for the advertisement information, for example. Examples of the additional information include limited-time sale information, event information such as tasting, privilege distribution, and the like.

The storage unit 11 stores the acquired coordinate information and virtual object. The storage unit 11 may store the user information, for example.

Further, the storage unit 11 may store, for example, the selected virtual object and a virtual point associated with the virtual object in a registration list. Thereby, the visitor can store an advertising target product or the like that he or she is concerned about, and can display the stored virtual object of the advertising target product or the like on the display screen to check it at any time. In addition, the registration list allows easy visiting and re-visiting to the specific position in cooperation with the route calculation unit 18 to be described below.

Further, for example, when the virtual object is displayed for a predetermined time or longer by the display unit 17, the storage unit 11 may store the selected virtual object and the virtual point associated with the virtual object in the browsing list. The time is not particularly limited, and is, for example, 5 seconds, 10 seconds, 30 seconds, or the like. Thereby, the visitor can display the virtual object such as the advertising target product on the display screen from the browsing list to check it at any time. In addition, the browsing list allows easy visiting and re-visiting to the specific position in cooperation with the route calculation unit 18 to be described below.

The imaging unit 13 images a real image and the fiducial marker 1. The real image is an image obtained by imaging a part of a specific area in the real space. The imaging unit 13 can perform imaging by a camera or the like of the terminal 4, for example. The imaging is not particularly limited, and may be, for example, continuous imaging (i.e., moving image) or intermittent imaging (i.e., still image).

The self-position specifying unit 14 specifies the self-position from the distance and the angle from the imaged fiducial marker 1. The distance and the angle can be calculated using, for example, a known technique, and specifically, can be calculated using, for example, an acceleration sensor, a gyro sensor, or the like mounted on the terminal 4.

The state detecting unit 15 detects a distance and an angle of view from the virtual point based on the self-position. The angle of view is an angle representing the range of the specific area that can be imaged in the real image obtained by the imaging unit 13.

The selection unit 16 selects any virtual object existing within the angle of view from the self-position. The selection is not particularly limited and the virtual object can be selected, for example, by tapping the icon on the display screen of the terminal 4 or by operating the terminal 4 so that the icon is displayed in the center of the display screen.

The display unit 17 executes processing of displaying the main object 2 of the virtual object existing within the angle of view from the self-position in such a manner that the virtual object is superimposed on the relative position on the real image. The processing is executed on the display device 106, for example. Specifically, for example, as shown in FIG. 4, the main objects 2a to 2e of all the booths appearing on the display screen of the terminal 4 are displayed in such a manner that they are superimposed on the relative positions on the real image. For example, the size of the main object 2 (icon) farther from the relative position may be smaller than that of the other main object 2, and the size of the main object 2 (icon) closer to the relative position may be larger than that of the other main object 2. That is, the main object 2e whose virtual point is far from its self-position may be displayed smaller than the main object 2a whose virtual point is close to its self-position, for example. On the other hand, the outer edge of the main object 2 may be colored according to the distance from the relative position, for example. Note that these display methods of the main object 2 are merely illustrative and are not particularly limited. The display unit 17 displays the main object 2 and the sub object 3 of the selected virtual object. In FIG. 4, the selected virtual object is the main object 2a, and the main object 2a and the sub object 3 corresponding to the main object 2a are displayed in such a manner that they are superimposed on the real image. The display position of the sub object 3 is not particularly limited, and may be displayed adjacent to the selected main object 2a, for example, or may be displayed at the bottom of the display screen.

The display unit 17 may display the virtual object existing within the angle of view from the self-position and within a freely-determined threshold value from the self-position in such a manner that the virtual object is superimposed on the relative position on the real image, for example. The threshold value is not particularly limited and, for example, a distance of 0 m to 100 m, 0 m to 10 m, 10 m to 50 m, 50 m to 100 m, or the like can be set freely. The threshold value may be set in advance, for example, or may be set by the user as appropriate. The threshold value can be set, for example, by operating a control bar (not shown) existing on the display screen of the terminal 4. The control bar may exist, for example, as a virtual object at any one end of the display screen. That is, the display unit 17 can preferentially display the main object 2 of the booth far from the self-position or preferentially display the main object 2 of the booth close to the self-position by the threshold value, for example. This allows the apparatus 10 to narrow down the virtual objects displayed on the display screen of the terminal 4, for example, thereby improving visibility.

When the acquisition unit 12 acquires the additional information, the display unit 17 displays the additional information, for example. The additional information may be displayed on the display screen using, for example, the notification function of the terminal 4. Visitors can visually and easily know where in the specific area gives a booth for a limited-time sale or an event, which is the additional information, by means of the apparatus 10. Thereby, for example, anxiety such as “I can't go to the booth because I don't know the location” or “The booth may be far from the current location” can be solved, and visitors will be less anxious.

When the imaging unit 13 continuously images the real image (i.e., in the case of a moving image), for example, the state detecting unit 15 further detects the movement from the specified self-position and the stop of the movement. When the movement is detected, the display unit 17 displays the virtual object in such a manner that the virtual object is superimposed on the real image before the movement. That is, during the movement, the real image displayed by the display unit 17 is in the state of a still image. On the other hand, when the stop of the movement is detected, the display unit 17 displays a virtual object existing within the angle of view from the self-position after the movement in such a manner that the virtual object is superimposed on the relative position on the real image after the movement. The movement is a movement from the specified self-position, and does not include, for example, an action of looking around the specified position (e.g., an action of holding up the terminal 4 in various directions). Thus, it is possible to prevent the visitor from moving while operating the apparatus 10 (terminal 4).

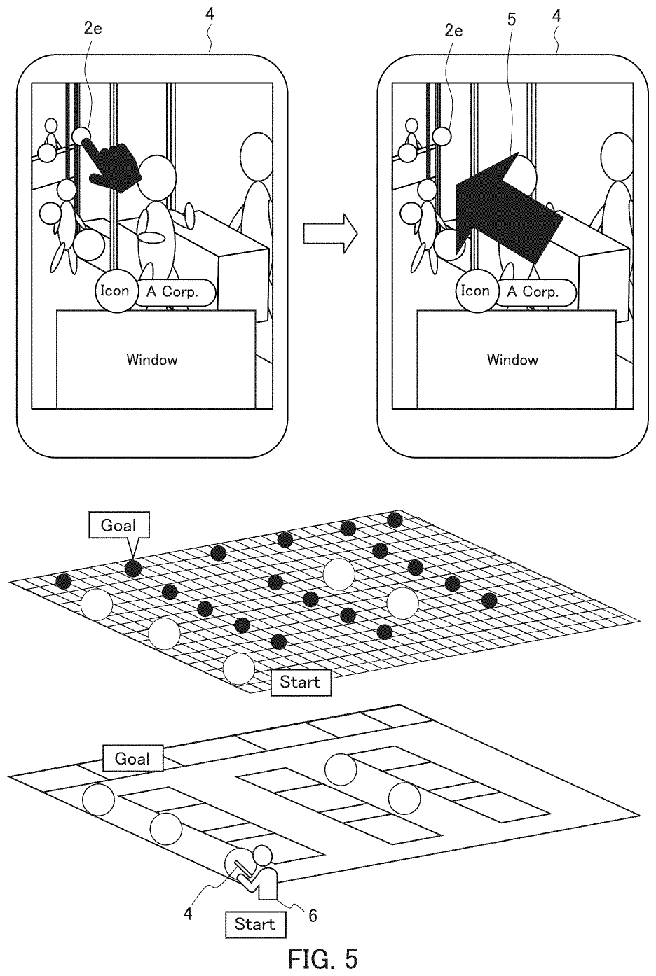

The apparatus 10 may further include, for example, a route calculation unit 18. In this case, the coordinate information further includes position information of an obstacle existing in the specific area. The obstacle is not particularly limited, and is, for example, an object such as a wall that prevents the passage of a user (visitor). The route calculation unit 18 calculates the shortest route from the self-position to the selected virtual point based on the coordinate information. The display unit 17 further displays the shortest route. FIG. 5 shows an example in which the apparatus 10 (the terminal 4) displays a route on the display screen of the terminal by the route calculation unit 18. In FIG. 5, the visitor 6 selects the main object 2e by the selection unit 16. The route calculation unit 18 calculates a route from the position (Start) of the visitor 6 to the virtual point (Goal) associated with the main object 2e (virtual object), and guides the visitor 6 to a specified position (Goal) corresponding to the virtual point. That is, the specific position is the destination of the visitor 6. The display unit 17 may display the guiding virtual object 5 such as an arrow and a text in such a manner that they are superimposed on the real image, for example. Thus, for example, even a person who is not good at reading the map can go to the destination with no stress. Further, the display unit 17 may display a map (2D object) (not shown) of the specific areas on the display image instead of or together with the guiding virtual object 5, for example. The map can be obtained, for example, by the acquisition unit 12. The self-position specified by the self-position specifying unit 14 may be displayed on the map, for example. The route calculation unit 18 may acquire the virtual points stored in the registration list and the browsing list, respectively, and calculate a route to the virtual points, for example. Generally, when the specific area is an indoor area or when the communication condition is not good, for example, a global positioning system (GPS) or the like cannot be used, and therefore, it is impossible to specify a self-position or calculate a route. However, since the apparatus 10 can specify the self-position by using the fiducial marker 1, the route can be calculated without being influenced by the environmental condition of the specific area or the like (when the specific area is an indoor area or when the communication condition is not good).

The apparatus 10 may, for example, further include a reservation unit 19. The reservation unit 19 can reserve at least one of a visit to an exhibitor of advertisement information of the selected virtual object and participation in an event held in the specific area. Generally, even if the visitors wanted to talk to the exhibitors, it was difficult for the visitors to talk to the exhibitors because the exhibitors were talking with other visitors or the booth was crowded, etc. However, the visitor can efficiently conduct a business negotiation with the exhibitor using the apparatus 10, for example. Examples of the event held in the specific area include a demonstration and a seminar. The event may be an event led by an organizer or an event led by an exhibitor. The apparatus 10 can calculate, for example, the shortest route from the self-position to a virtual point such as the booth to be visited, the stage to hold the event, or the like (hereinafter, also referred to as a visiting place) by the route calculation unit 18.

The apparatus 10 may further include, for example, an input unit and an extraction unit. The input unit inputs a freely-selected word. The extraction unit extracts the virtual object including the input freely-selected word. The freely-selected word may be stored in the storage unit 11, for example. The freely-selected word is not particularly limited, and may be two or more words. Further, a representative word (also referred to as a tag) may be set for the virtual object, and the input unit may further input a freely-selected representative word. The extraction unit may further extract the virtual object including the input representative word. The freely-selected representative word is not particularly limited, and may be two or more representative words. In these cases, the display unit 17 displays the virtual object, which is existing within the angle of view and extracted, in such a manner that the virtual object is superimposed on the real image. As a result, since only the advertising target products or the like (virtual object) of interest can be displayed on the display screen, the visibility is improved.

The apparatus 10 may further include, for example, a recommendation unit. The recommendation unit recommends other advertisement information to the user based on the user information. More specifically, for example, the advertising target product or the like which other user having the same attribute (e.g., the same profession) as the attribute information of the user pays attention is recommended. Whether or not the advertising target product or the like is of interest to the other user can be determined by, for example, whether or not the advertising target product or the like is stored in the browsing list and the registration list of the other user's terminal. Further, when the user mainly browses the advertising target products of the same line, the advertising target products of the same line which the user has not been browsed are recommended. The line can be systematized by, for example, extracting the same or similar text information and the representative word or the like from the text information representing the contents of the advertisement information and the representative word or the like. In this case, the display unit 17 displays the virtual object of the recommended advertisement information.

The apparatus 10 may further include, for example, a translation unit. The translation unit can translate the language displayed by the display unit 17 into a freely-selected language. The language displayed by the display unit 17 is not particularly limited and examples thereof include the virtual object, an item of the attribute information, the additional information, the advertisement information, the representative word, the freely-selected word, the guiding virtual object 5, an explanatory virtual object to be described below, and explanatory information. Thus, the translation unit can change the language displayed on the display screen by the display unit 17.

A marker unique to each of the specific positions may be installed at the specific position. Unlike the fiducial marker 1 for specifying the self-position, the marker is a marker for the advertising target product or the like. The marker is not particularly limited, and is, for example, an AR marker or the like. The number of the markers is not particularly limited, and for example, it is preferable that the number of the markers be one for one advertising target product or the like. The installation position of the marker is not particularly limited as long as it is installed within each booth at the specific position. In this case, the imaging unit 13 images the marker and at least one of a real advertising target product and a real advertising target service. Then, the acquisition unit 12 acquires the explanatory virtual object from the imaged marker. The explanatory virtual object includes explanatory information on at least one of the real advertising target product and the real advertising target service. The explanatory virtual object is not particularly limited, and may be an image, text information, or a combination thereof Then, the display unit 17 displays the explanatory virtual object at a specific part of at least one of the real advertising target product and the real advertising target service. Specifically, for example, in the case where the advertising target product or the like is “wine”, when the camera of the terminal 4 is held over a wine which is displayed, an explanation of the brand is displayed as the explanatory information at a specific part (e.g., label part) of the wine. In addition, in the case where the advertising target product or the like is “a vehicle engine”, for example, when the camera of the terminal 4 is held over an engine which is displayed, an explanation of each part constituting the engine is displayed as the explanatory information. The display unit 17 may display, for example, the explanatory virtual object different for each attribute information. Specifically, for example, when the specific area is a food trade fair, the superiority of the company's product compared with other competing products is displayed as explanatory information to a retailer (visitor). On the other hand, for example, the cooking method is displayed as explanatory information to the restaurant participant.

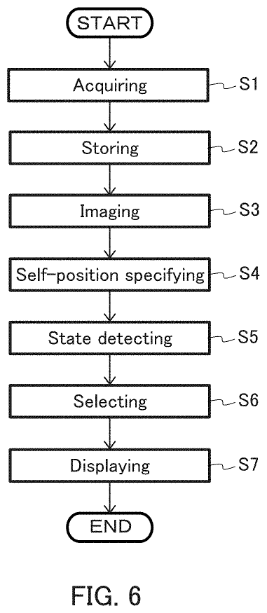

Next, an example of the display method of the present example embodiment will be described with reference to the flowchart of FIG. 6. The display method of the present example embodiment is implemented as follows, for example, using the display apparatus 10 of FIG. 1. The display method of the present example embodiment is not limited to the use of the display apparatus 10 of FIG. 1. The display method of the present example embodiment is, for example, processing in the visitor's terminal (e.g., a smartphone or the like).

First, in step S1, the acquisition unit 12 acquires coordinate information associated with a fiducial marker installed in a specific area of a real space and a virtual object including advertisement information. Next, in step S2, the storage unit 11 stores the acquired coordinate information and virtual object. Then, in step S3, the imaging unit 13 images a real image and the fiducial marker (S3). Next, in step S4, the self-position specifying unit 14 specifies the self-position from the distance and the angle with the imaged fiducial marker. Next, in step S5, the state detecting unit 15 detects the distance and the angle of view from the virtual point based on the self-position. Next, in step S6, the selection unit 16 selects any virtual object existing within the angle of view from the self-position. Then, in step S7, the display unit 17 displays the main object of the virtual object existing within the angle of view from the self-position in such a manner that the main object is superimposed on the relative position on the real image and displays a main object and a sub object of the selected virtual object, and the processing is ended (END). In step S7, for example, the display unit 17 may display the virtual object existing within the angle of view from the self-position and within a freely-determined threshold value from the self-position in such a manner that the virtual object is superimposed on the relative position on the real image, for example

Step S1 may further acquire user information including attribute information and behavior information, for example. Step S2 may store the user information.

Step S1 may further acquire additional information to the advertisement information, for example. Step S7 may display the additional information.

Step S3 may continuously image the real image, for example. In this case, step S5 further detects the movement from the specified self-position and the stop of the movement. Then, when the movement is detected, step S7 displays the virtual object in such a manner that the virtual object is superimposed on the real image before the movement, and when the stop of the movement is detected, step S7 displays the virtual object existing within the angle of view from the self-position after the movement in such a manner that the virtual object is superimposed on the relative position on the real image after the movement.

Step S2 may store the selected virtual object and the virtual point associated with the virtual object in the registration list, for example. Further, when the virtual object is displayed for a predetermined time or longer by step S7, step S2 stores the selected virtual object and the virtual point associated with the virtual object in the browsing list.

Further, for example, after step S6, the route calculation unit 18 may calculate the shortest route from the self-position to the selected virtual point based on the coordinate information. In this case, step S7 further displays the shortest route.

Further, for example, after step S6, the reservation unit 19 may reserve at least one of the visit to the exhibitor of the advertisement information of the selected virtual object and the participation in the event held in the specific area. It is preferable that the step of reserving is performed before the step of calculating the shortest route because, for example, a route to the visit location can be calculated.

When the apparatus 10 includes the input unit and the extraction unit, for example, after step S6, the input unit may input a freely-selected word, and the extraction unit may extract the virtual object including the input freely-selected word. Step S7 displays the virtual object, which is existing within the angle of view and extracted, in such a manner that the virtual object is superimposed on the real image. When a representative word is set for the virtual object, after step S6, the input unit may input a freely-selected representative word and the extraction unit may extract the virtual object including the input representative word, for example.

When the apparatus 10 includes the recommendation unit, for example, the recommendation unit may recommend other advertisement information to the user based on the user information before step S7. In this case, step S7 displays a virtual object of the recommended advertisement information.

When the apparatus 10 includes the translation unit, for example, the translation unit may translate the language displayed by the display unit 17 into a freely-selected language after step S1 and before step S7.

Further, when a marker unique to each of the specific positions is installed at the specific position, for example, step S3 images the marker and at least one of the real advertising target product and the real advertising target service. Then, the acquisition unit 12 acquires an explanatory virtual object from the imaged marker. Step S7 displays the explanatory virtual object in a specific part of at least one of the real advertising target product and the real advertising target service. Step S7 may display the explanatory virtual object different for each attribute information.

According to the present example embodiment, since it is not necessary to prepare a marker for each advertising target product or the like to be promoted, for example, products and the like can be promoted at low cost and easily. Conventional AR include a location-based type, a vision-based marker type, and a vision-based marker-less type. The location-based type cannot support the use of AR in an environment where GPS or the like cannot be used (e.g., indoor, communication condition is poor, and the like). In addition, since the use of a device such as beacon and WiFi results in higher costs, it was not profitable for short-term events, for example. However, according to the display apparatus 10 of the present example embodiment, for example, it is possible to specify the self-position by imaging the fiducial marker 1 even in an environment where GPS or the like cannot be used. In addition, the display apparatus 10 does not require expensive devices such as beacon and WiFi, which results in lower costs, and thus the display apparatus 10 can be efficiently used for short-term events. Since the vision-based marker type requires to prepare a marker for each booth in the event with a large number of booths, it is laborious and costly. In addition, there are places where markers cannot be installed in some venues. Further, it is troublesome for the user to read the marker each time. However, according to the display apparatus 10 of the present example embodiment, it is not necessary to prepare a marker for each booth because the display apparatus 10 acquires a virtual object associated with the virtual point and coordinate information on which the virtual points are mapped. In addition, since the apparatus 10 can display a virtual object existing within an angle of view from its self-position, the user does not need to read the marker each time. The vision-based marker-less type has been difficult to add information (virtual object) to a scene (real image) because the completion of the booth setting is the latest day before the event holding date or the like. However, according to the display apparatus 10 of the present example embodiment, for example, it is possible to add information (virtual object) to a scene (real image) by acquiring the coordinate information.

### Second Example Embodiment

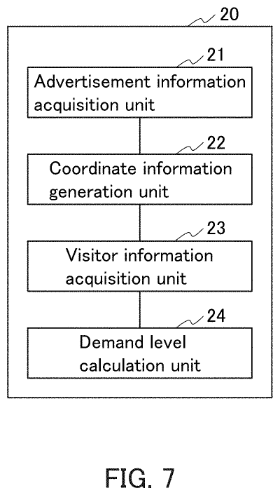

FIG. 7 is a block diagram showing the configuration of an example of a demand level calculation apparatus 20 of the present example embodiment. As shown in FIG. 7, the apparatus 20 includes an advertisement information acquisition unit 21, a coordinate information generation unit 22, a visitor information acquisition unit 23, and a demand level calculation unit 24. The apparatus 20 may further include, for example, a reservation information acquisition unit (not shown) or the like.

The apparatus 20 may be, for example, a single apparatus including the above-described components, or may be an apparatus to which the components are connectable via a communication network. The communication network is not particularly limited, and is, for example, the same as described above. The apparatus 20 may be incorporated in a server as a system, for example. The apparatus 20 may be, for example, a personal computer (PC, e.g., desktop PC, notebook PC) or an organizer's terminal in a specific area (e.g., a smartphone, a mobile phone, a wearable terminal such as a spectacle type, a wristwatch type, or the like) to be described below, in which the program of the present invention is installed. The organizer in the specific area means, for example, an organizer (also referred to as a manager or planner) of an event or the like in the specific area. The organizer's terminal can be used, for example, in or out of the specific area and for any period of time.

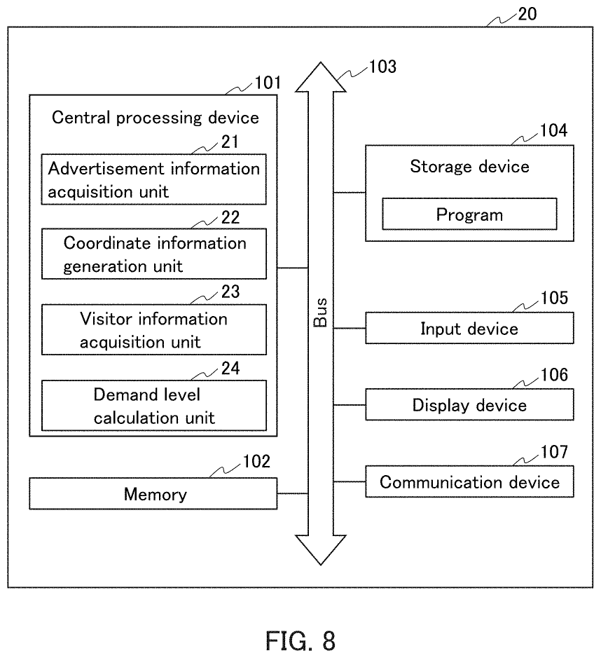

FIG. 8 shows a block diagram of the hardware configuration of the apparatus 20. The apparatus 20 includes, for example, a central processing device (CPU, GPU, etc.) 101, a memory 102, a bus 103, a storage device 104, an input device 105, a display device (display) 106, a communication device 107, and the like. The respective components of the apparatus 20 are connected to each other via a bus 103 via respective interfaces (I/F). Regarding the respective components of the hardware configuration of the apparatus 20, for example, reference can be made to the description of the display apparatus 10 of the first example embodiment.

The central processing device 101 functions as, for example, an advertisement information acquisition unit 21, a coordinate information generation unit 22, a visitor information acquisition unit 23, and a demand level calculation unit 24. The central processing device 101 may further function as, for example, the reservation information acquisition unit or the like.

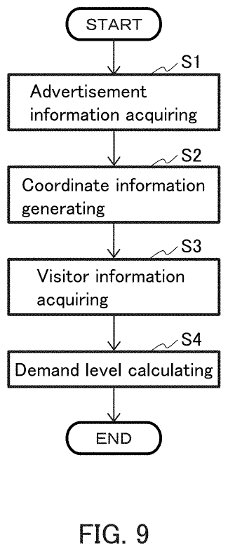

Next, an example of the demand level calculation method of the present example embodiment will be described with reference to the flowchart of FIG. 9. The demand level calculation method of the present example embodiment is implemented as follows using, for example, the demand level calculation apparatus 20 of FIG. 7. The demand level calculation method of the present example embodiment is not limited to the use of the demand level calculation apparatus 20 of FIG. 7. The demand level calculation method of the present example embodiment is, for example, processing in the organizer's terminal.

First, in step S1, the advertisement information acquisition unit 21 acquires advertisement information on at least one of an advertising target product and an advertising target service (hereinafter, also referred to as an advertising target product or the like) in the specific area. The advertising target product or the like is the same as the advertising target product or the like in the display apparatus 10 of the first example embodiment, for example.

Next, in step S2, the coordinate information generation unit 22 generates coordinate information associated with a fiducial marker installed in a specific area of a real space. The coordinate information is, for example, coordinate information shown in FIG. 3. The fiducial marker is, for example, the same as the fiducial marker 1 in the display apparatus 10 of the first example embodiment. The coordinate information generation unit 22 maps a virtual point indicating a specific position in the specific area on the coordinate information, and associates the virtual point with the advertisement information.

Next, in step S3, the visitor information acquisition unit 23 acquires visitor information including attribute information and behavior information of a visitor in the specific area. The visitor information is, for example, the same as the user information in the display apparatus 10.

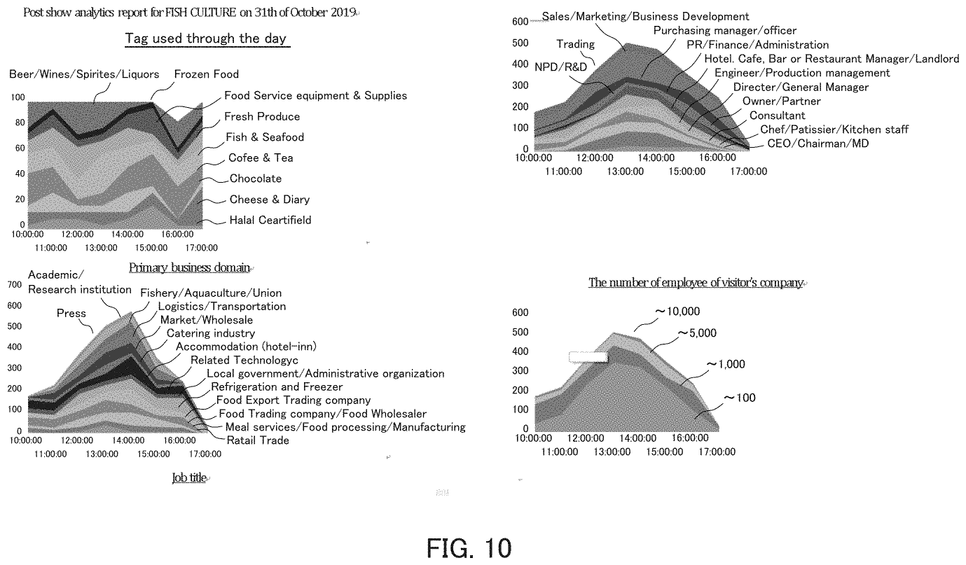

Then, in step S4, the demand level calculation unit 24 calculates the magnitude of the demand level for the advertisement information based on the advertisement information and the visitor information, and the processing is ended (END). That is, the demand level is a value indicating the level of interest of the visitor in the advertising target product or the like. The calculation data is, for example, data obtained by calculating the magnitude of the demand level based on any one or a combination of the profession of the visitor, the tag extracted by the visitor's terminal, the time the visitor visited his/her own booth, and the like. Specifically, while FIG. 10 shows an example of the calculated demand level data (also referred to as calculation data), it is merely illustrative and the present invention is not limited thereto. The calculation data may be a plurality of pieces.

The apparatus 20 may further include, for example, a reservation information acquisition unit. The reservation information acquisition unit acquires reservation information indicating a participation reservation from the visitor for an event held in the specific area, for example, before step S4. Examples of the event held in the specific area include a demonstration and a seminar, which is the same as described above. The event may be an event led by an organizer or an event led by an exhibitor. The organizer can also manage, for example, the time setting (start time, end time) of an event to be held in the specific area using the apparatus 20. For example, the apparatus 20 may further determine whether or not to accept the reservation and may generate reservation confirmation information indicating the result of the determination. As a result, the demand level calculation unit 24 can further calculate the magnitude of the demand level based on the reservation information, for example.

According to the present example embodiment, since it is not necessary to prepare a marker for each advertising target product or the like to be promoted by generating the coordinate information, for example, products and the like can be promoted at low cost and easily. With the conventional technique, the effect of promoting a product or the like is unknown. However, since the apparatus 20 can calculate the demand level of the advertising target product or the like for which the effect of advertisement (promotion) is known, for example, it is possible to provide the calculation data to an exhibitor who exhibits at the event or the like.

### Third Example Embodiment

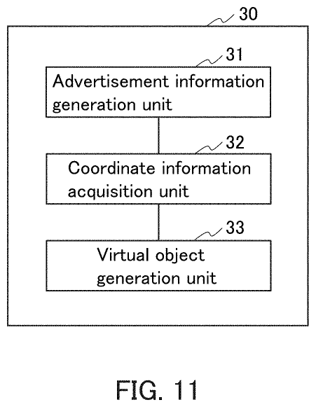

FIG. 11 is a block diagram showing the configuration of an example of an advertisement information generation apparatus 30 of the present example embodiment. As shown in FIG. 11, the apparatus 30 includes an advertisement information generation unit 31, a coordinate information acquisition unit 32, and a virtual object generation unit 33. The apparatus 30 may further include, for example, a visitor information acquisition unit (not shown), a demand level calculation unit (not shown), a reservation information acquisition unit (not shown), the additional information distribution unit, and the like.

The apparatus 30 may be, for example, a single apparatus including the above-described components, or may be an apparatus to which the components are connectable via a communication network. The communication network is not particularly limited, and is, for example, the same as described above. The apparatus 30 may be incorporated in a server as a system, for example. The apparatus 30 may be, for example, a personal computer (PC, e.g., desktop PC, notebook PC) or an exhibitor's terminal in a specific area (e.g., a smartphone, a mobile phone, a wearable terminal such as a spectacle type, a wristwatch type, or the like) to be described below, in which the program of the present invention is installed. The exhibitor in the specific area means, for example, an exhibitor of an event or the like in the specific area. The exhibitor's terminal can be used, for example, in or out of the specific area and for any period of time.

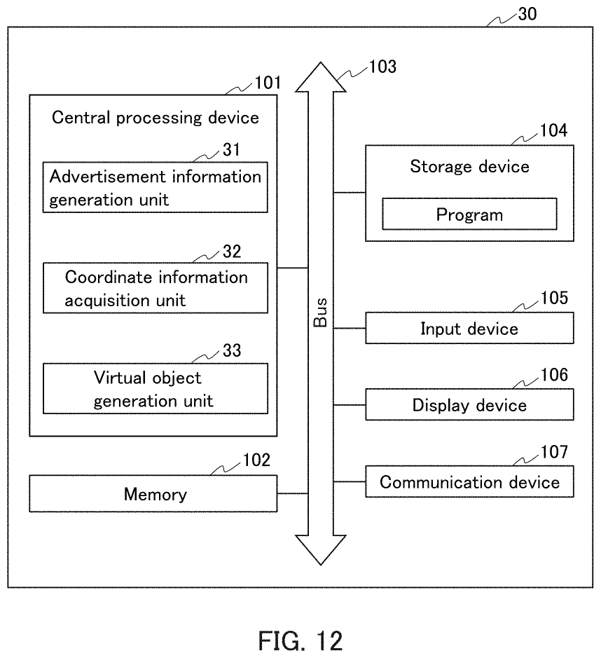

FIG. 12 shows a block diagram of the hardware configuration of the apparatus 30. The apparatus 30 includes, for example, a central processing device (CPU, GPU, etc.) 101, a memory 102, a bus 103, a storage device 104, an input device 105, a display device (display) 106, a communication device 107, and the like. The respective components of the apparatus 30 are connected to each other via a bus 103 via respective interfaces (I/F). Regarding the respective components of the hardware configuration of the apparatus 30, for example, reference can be made to the description of the display apparatus 10 of the first example embodiment.

The central processing device 101 functions as, for example, an advertisement information generation unit 31, a coordinate information acquisition unit 32, and a virtual object generation unit 33. The central processing device 101 may further function as, for example, the visitor information acquisition unit, the demand level calculation unit, the reservation information acquisition unit, the additional information distribution unit, and the like.

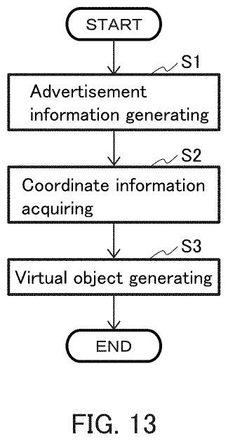

Next, an example of the advertisement information generation method of the present example embodiment will be described with reference to the flowchart of FIG. 13. The advertisement information generation method of the present example embodiment is implemented as follows using, for example, the advertisement information generation apparatus 30 of FIG. 11. The advertisement information generation method of the present example embodiment is not limited to the use of the advertisement information generation apparatus 30 of FIG. 11. The advertisement information generation method of the present example embodiment is, for example, processing in the exhibitor's terminal.

First, in step S1, the advertisement information generation unit 31 generates advertisement information on at least one of an advertising target product and an advertising target service (hereinafter, also referred to as an advertising target product or the like). The advertising target product or the like is the same as the advertising target product or the like in the display apparatus 10, for example.

Next, in step S2, the coordinate information acquisition unit 32 acquires coordinate information associated with the fiducial marker installed in a specific area of the real space. A virtual point indicating a specific position in the specific area is mapped on the coordinate information. The coordinate information is, for example, coordinate information shown in FIG. 3. The fiducial marker is, for example, the same as the fiducial marker 1 in the display apparatus 10 of the first example embodiment.

Next, in step S3, the virtual object generation unit 33 generates a virtual object associated with the virtual point and the advertisement information. The virtual object is composed of a main object and a sub object. The main object is an image object representing contents of the advertisement information. The sub object is an object to which text information representing the contents of the advertisement information is added. Specifically, for example, reference can be made to the description as to the display apparatus 10 of the first example embodiment.

For example, in step S3, the virtual object generation unit 33 may further set a representative word for the virtual object. The representative word is, for example, the same as the representative word in the display apparatus 10 of the first example embodiment. Setting the representative word is also referred to as tagging.

Further, in step S3, the virtual object generation unit 33 may generate, for example, an explanatory virtual object different for each attribute information of the user of the apparatus displaying the virtual object. The explanatory virtual object is, for example, the same as the virtual object in the display apparatus 10 of the first example embodiment, and is a virtual object including explanatory information on at least one of a real advertising target product and a real advertising target service. The apparatus displaying the virtual object is, for example, the display apparatus 10 of the first example embodiment. The attribute information is, for example, the same as the attribute information in the display apparatus 10 of the first example embodiment.

The apparatus 30 may further include, for example, a visitor information acquisition unit and a demand level calculation unit. The visitor information acquisition unit acquires visitor information including attribute information and behavior information of a visitor in the specific area, for example, after step S1. The visitor information is, for example, the same as the user information in the display apparatus 10 of the first example embodiment. The demand level calculation unit calculates the magnitude of the demand level for the advertisement information based on the advertisement information and the visitor information after the step by the visitor information acquisition unit. Regarding the demand level calculation unit, for example, reference can be made to the description as to the demand level calculation unit 24 in the demand level calculation apparatus 20 of the second example embodiment. Each of the steps by the visitor information acquisition unit and the demand level calculation unit may be processed in parallel with step S2 and step S3, for example. As a result, on the exhibitor side, the demand level can be calculated, and the calculated result can be used for marketing or the like.

The apparatus 30 may further include, for example, a reservation information acquisition unit. The reservation information acquisition unit acquires reservation information indicating a reservation for a visit from the visitor, for example, after step S1. For example, the apparatus 30 may further determine whether or not to accept the reservation, and generate reservation confirmation information indicating a result of the determination. Thereby, exhibitors and visitors can smoothly conduct business negotiations and the like, for example.

The apparatus 30 may further include, for example, an additional information distribution unit. In this case, step S1 further generates additional information for the advertisement information. The additional information is, for example, the same as that of the display apparatus 10 of the first example embodiment. The additional information distribution unit distributes the additional information to a specific visitor's terminal after step S3, for example. The specific visitor's terminal is not particularly limited and may be set freely, and maybe, for example, the terminals of all visitors, the terminals of visitors having certain attribute information, the terminals of visitors around their own booth, and the like.

According to the present example embodiment, since it is not necessary to prepare a marker for each advertising target product or the like to be promoted, it is possible to promote the products and the like at low cost and easily.

### Fourth Example Embodiment

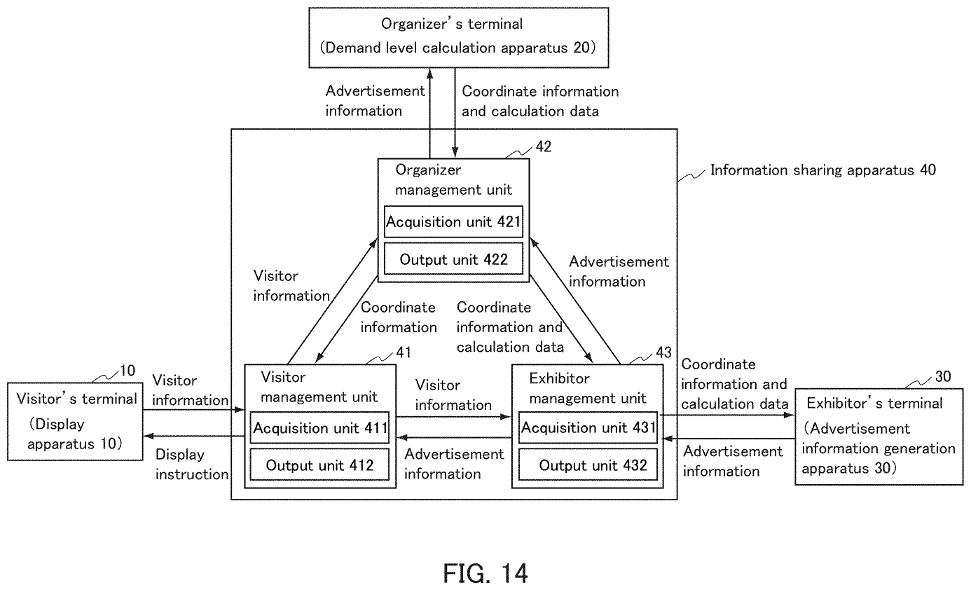

FIG. 14 is a block diagram showing the configuration of an example of an information sharing apparatus 40 of the present example embodiment. As shown in FIG. 14, the apparatus 40 includes a visitor management unit 41, an organizer management unit 42, and an exhibitor management unit 43. The visitor management unit 41 includes an acquisition unit 411 and an output unit 412. The organizer management unit 42 includes an acquisition unit 421 and an output unit 422. The exhibitor management unit 43 includes an acquisition unit 431 and an output unit 432.

The apparatus 40 may be, for example, a single apparatus including the above-described components, or may be an apparatus to which the components are connectable via a communication network. The communication network is not particularly limited, and is the same as described above, for example. The apparatus 40 may be incorporated in a server as a system, for example. The apparatus 40 may be, for example, a personal computer (PC, e.g., desktop PC, notebook PC), a terminal (e.g., a smartphone, a mobile phone, a wearable terminal such as a spectacle type, a wristwatch type, or the like), or an administrator's server that administrates information sharing of terminals of the organizer, the visitor, and the exhibitor, in which the program of the present invention is installed. The administrator's server can be used, for example, in or out of the specific area and for any period of time.

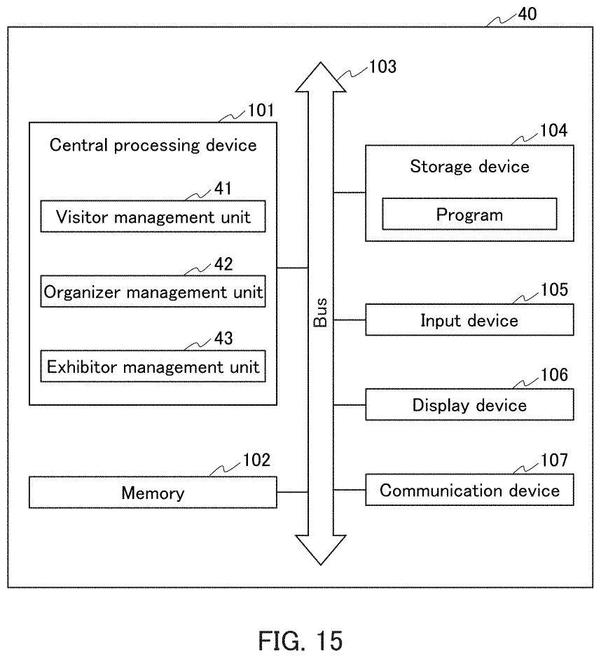

FIG. 15 shows a block diagram of the hardware configuration of the apparatus 40. The apparatus 40 includes, for example, a central processing device (CPU, GPU, etc.) 101, a memory 102, a bus 103, a storage device 104, an input device 105, a display device (display) 106, a communication device 107, and the like. The respective components of the apparatus 40 are connected with one another via a bus 103 through respective interfaces (I/F). Regarding each component of the hardware configuration of the apparatus 40, for example, reference can be made to the description as to a display apparatus 10 of the first example embodiment.

The central processing device 101 functions as, for example, the visitor management unit 41, the organizer management unit 42, and the exhibitor management unit 43.

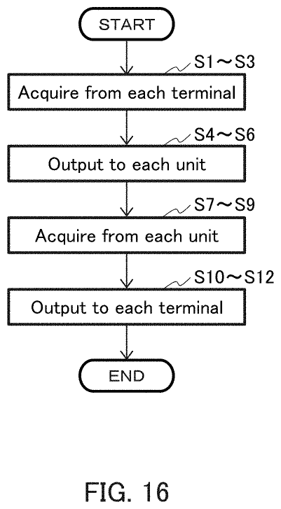

Next, an example of the information sharing method of the present example embodiment will be described with reference to the flowchart of FIG. 16. The information sharing method of the present example embodiment is implemented as follows using the information sharing apparatus 40 of FIG. 14, for example. The information sharing method of the present example embodiment is not limited to the use of the information sharing apparatus 40 of FIG. 14. The information sharing method of the present example embodiment is, for example, processing in a server of an administrator who administrates information sharing of terminals of the organizer, the visitor, and the exhibitor.

First, in step S1, the acquisition unit 411 of the visitor management unit 41 acquires visitor information from the visitor's terminal. The visitor's terminal is not particularly limited, and is, for example, the display apparatus 10 of the first example embodiment. The visitor information is, for example, the same as the user information in the display apparatus 10 of the first example embodiment. In step S2, the acquisition unit 421 of the organizer management unit 42 acquires coordinate information and calculation data obtained by calculating the magnitude of the demand level for the advertisement information from the organizer's terminal. The calculation data is the same as the calculation data in the demand level calculation apparatus 20 of the second example embodiment, and a plurality of pieces of the calculation data may be acquired. The coordinate information is the same as the coordinate information in the display apparatus 10 of the first example embodiment. The organizer's terminal is not particularly limited, and is, for example, the demand level calculation apparatus 20 of the second example embodiment. In step S3, the acquisition unit 431 of the exhibitor management unit 43 acquires advertisement information from the exhibitor's terminal. The advertisement information is the same as the advertisement information in the display apparatus 10 of the first example embodiment. The exhibitor's terminal is not particularly limited, and is, for example, the advertisement information generation apparatus 30 of the third example embodiment. The order of the processing from step S1 to step S3 is not particularly limited.

In step S4, the output unit 412 of the visitor management unit 41 outputs the visitor information to the organizer management unit 42 and the exhibitor management unit 43. In step S5, the output unit 422 of the organizer management unit 42 outputs the coordinate information to the visitor management unit 41 and the exhibitor management unit 43 and outputs the calculation data to the exhibitor management unit 43. In step S6, the output unit 432 of the exhibitor management unit 43 outputs the advertisement information to the organizer management unit 42 and the visitor management unit 41. The order of processing from step S4 to step S6 is not particularly limited, and may be processed following step S1 to step S3.

Next, in step S7, the acquisition unit 411 of the visitor management unit 41 acquires coordinate information associated with a fiducial marker installed in a specific area of a real space from the organizer management unit 42 and acquires advertisement information including a virtual object from the exhibitor management unit 43. In step S8, the acquisition unit 421 of the organizer management unit 42 acquires visitor information from the visitor management unit 41 and acquires the advertisement information from the exhibitor management unit 43. In step S9, the acquisition unit 431 of the exhibitor management unit 43 acquires the calculation data and the coordinate information from the organizer management unit 42 and the visitor information from the visitor management unit 41. In step S9, when there are a plurality of pieces of the calculation data, the acquisition unit 431 of the exhibitor management unit 43 may acquire only a specific calculation data from the organizer management unit 42, for example. More specifically, for example, the acquisition unit 431 of the exhibitor management unit 43 can acquire only data of the demand level calculated based on the profession of the visitor, from the plurality of pieces of calculation data. The order of processing from step S7 to step S9 is not particularly limited, and may be processed following step S4 to step S6.

Next, in step S10, the output unit 412 of the visitor management unit 41 outputs an instruction to display a main object of the virtual object existing within an angle of view from a visitor's self-position on the visitor's terminal in such a manner that the main object is superimposed on a relative position on a real image imaged by the visitor's terminal, and to display a main object and a sub object of a virtual object selected by the visitor. In step S11, the output unit 422 of the organizer management unit 42 outputs the advertisement information to the organizer's terminal. In step S12, the output unit 432 of the exhibitor management unit 43 outputs the calculation data and the coordinate information to the exhibitor's terminal. The order of processing from step 10 to step S12 is not particularly limited, and may be processed following step S7 to step S9. Then, after the processing from step 10 to step S12, the processing is ended (END).

For example, in step 12, instead of the organizer management unit 42 acquiring the calculation data from the organizer's terminal, the output unit 432 of the exhibitor management unit 43 may further output the visitor information to the exhibitor's terminal and output an instruction to calculate the magnitude of the demand level for the advertisement information. Thereby, the magnitude of the demand level for the advertisement information can be calculated in the exhibitor's terminal.

In step S1, the acquisition unit 411 of the visitor management unit 41 may further acquire reservation information from the visitor's terminal. The reservation information is information indicating that at least one of participation in an event held in the specific area and a visit to an exhibitor has been reserved, and specifically, reference can be made to the description as to the reservation information in the first to the third example embodiments. In this case, the output unit 412 of the visitor management unit 41 further outputs the reservation information to at least one of the organizer management unit 42 and the exhibitor management unit 43 in step S4. When the reservation information is output from the visitor management unit 41, the output unit 422 of the organizer management unit 42 further outputs the reservation information to the organizer's terminal in step S11. When the reservation information is output from the visitor management unit 41, the output unit 432 of the exhibitor management unit 43 further outputs the reservation information to the exhibitor's terminal in step S12. In this case, at least one of the acquisition unit 421 of the organizer management unit 42 and the acquisition unit 431 of the exhibitor management unit 43 to which the reservation information has been output may acquire reservation confirmation information indicating whether or not the reservation has been finalized from at least one of the organizer's terminal and the exhibitor's terminal after step S12. At least one of the output unit 422 of the organizer management unit 42 and the output unit 432 of the exhibitor management unit 43 outputs the reservation confirmation information to the visitor management unit 41. The output unit 412 of the visitor management unit 41 outputs the reservation confirmation information to the visitor's terminal.

According to the present example embodiment, it is possible to promote products and the like at low cost and easily in the same manner as in other example embodiments. In addition, by controlling information sharing of the terminals, the AR can be realized without using the global positioning system (GPS) or the like, for example.

### Fifth Example Embodiment

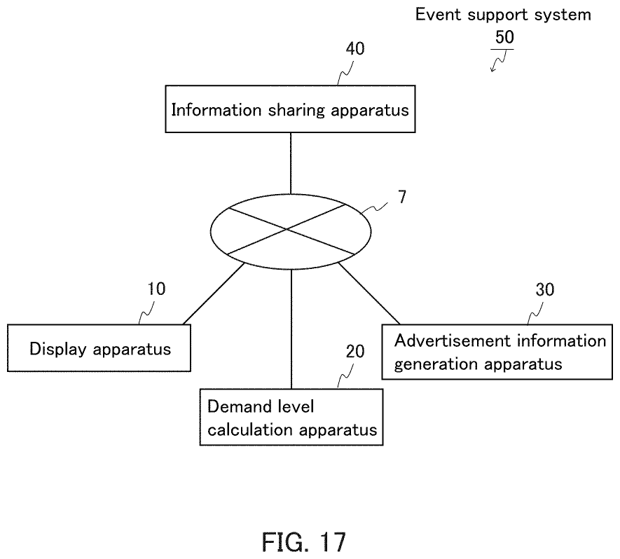

FIG. 17 is a schematic diagram showing the configuration of an example of an event support system 50 of the present example embodiment. As shown in FIG. 17, the system 50 includes the display apparatus 10 of the first example embodiment, the demand level calculation apparatus 20 of the second example embodiment, the advertisement information generation apparatus 30 of the fourth example embodiment, and the information sharing apparatus 40 of the fourth example embodiment. In the information sharing apparatus 40, the visitor's terminal is the display apparatus 10 of the first example embodiment, the organizer's terminal is the demand level calculation apparatus 20 of the second example embodiment, and the exhibitor's terminal is the advertisement information generation apparatus 30 of the third example embodiment. The information sharing apparatus 40 can be connected to the display apparatus 10, the demand level calculation apparatus 20, and the advertisement information generation apparatus 30 via the communication network 7. The communication network 7 is, for example, the same as described above. The event support system 50 is also referred to as, for example, an event support apparatus 50. The production method of the event support system 50 of the present example embodiment is a production method of connecting the display apparatus 10, the demand level calculation apparatus 20, and the advertisement information generation apparatus 30 via the communication network 7.

According to the present example embodiment, since the information sharing apparatus can be performed by connecting with the respective apparatuses of the visitor, the organizer, and the exhibitor, it is possible to promote the products and the like at low cost and easily.

### Sixth Example Embodiment

The program of the present example embodiment is a program for causing a computer to execute each step of each of the methods of first to fifth example embodiments as a procedure. In the present invention, the “procedure” may be read as “processing”. The computer is not particularly limited, and may be, for example, the personal computer, or a terminal such as a smartphone, a mobile phone, a wearable terminal such as a spectacle type, a wristwatch type, or the like. Further, the program of the present example embodiment may be distributed by, for example, a server (also referred to as a distribution server). Specifically, for example, the distribution server distributes the program of the information sharing method of the fourth example embodiment to the information sharing apparatus 40. Then, the program of the display method of the first example embodiment is distributed to the display apparatus 10 via the information sharing apparatus 40, the program of the demand level calculation method of the second example embodiment is distributed to the demand level calculation apparatus 20, and the program of the advertisement information generation method of the third example embodiment is distributed to the advertisement information generation apparatus 30. The program of the present example embodiment may be recorded on, for example, a computer-readable recording medium. Examples of the recording medium include a hard disk (HD), a floppy® disk (FD), a CD-ROM, a CD-R, a CD-RW, an MO, a DVD, a flash memory, and a memory card.

While the present invention has been described above with reference to illustrative example embodiments, the present invention is by no means limited thereto. Various changes and variations that may become apparent to those skilled in the art may be made in the configuration and specifics of the present invention without departing from the scope of the present invention.

This application claims priority from Japanese Patent Application No. 2019-194795 filed on Oct. 25, 2019. The entire subject matter of the Japanese Patent Applications is incorporated herein by reference.

(Supplementary Notes)

Some or all of the above example embodiments may be described as in the following

Supplementary Notes, but are not limited thereto.

### (Supplementary Note 1)

A display apparatus, including:

a storage unit;

an acquisition unit;

an imaging unit,

a self-position specifying unit;

a state detecting unit;

a selection unit; and

a display unit, wherein

the acquisition unit acquires coordinate information associated with a fiducial marker installed in a specific area of a real space and a virtual object including advertisement information,

a virtual point indicating a specific position in the specific area is mapped on the coordinate information,

the advertisement information is information on at least one of an advertising target product or an advertising target service,

the virtual object is associated with the virtual point and composed of a main object and a sub object,

the main object is an image object representing contents of the advertisement information,

the sub object is an object to which text information representing the contents of the advertisement information is added,

the storage unit stores the acquired coordinate information and virtual object,

the imaging unit images a real image and the fiducial marker,

the self-position specifying unit specifies a self-position from a distance and an angle from the imaged fiducial marker,

the state detecting unit detects a distance and an angle of view from the virtual point based on the self-position,

the selection unit selects any virtual object existing within an angle of view from the self-position, and

the display unit displays a main object of the virtual object existing within the angle of view from the self-position in such a manner that the main object is superimposed on a relative position on the real image and displays a main object and a sub object of the selected virtual object.

### (Supplementary Note 2)

The display apparatus according to Supplementary Note 1, wherein

the acquisition unit further acquires user information including attribute information and behavior information, and

the storage unit stores the user information.

### (Supplementary Note 3)

The display apparatus according to Supplementary Note 1 or 2, wherein

the display unit displays the virtual object existing within an angle of view from the self-position and existing within a freely-determined threshold value from the self-position in such a manner that the virtual object is superimposed on the relative position on the real image.

### (Supplementary Note 4)

The display apparatus according to any one of Supplementary Notes 1 to 3, wherein

the acquisition unit further acquires additional information for the advertisement information, and

the display unit displays the additional information.

### (Supplementary Note 5)

The display apparatus according to any one of Supplementary Notes 1 to 4, wherein

the imaging unit continuously images the real image,

the state detecting unit further detects a movement from the specified self-position and a stop of the movement,

when the movement is detected, the display unit displays the virtual object in such a manner that it is superimposed on the real image before the movement, and

when the stop of the movement is detected, the display unit displays a virtual object existing within an angle of view from the self-position after the movement in such a manner that the virtual object is superimposed on the relative position on the real image after the movement.

### (Supplementary Note 6)

The display apparatus according to any one of Supplementary Notes 1 to 5, wherein

the storage unit stores the selected virtual object and a virtual point associated with the virtual object in a registration list.

### (Supplementary Note 7)

The display apparatus according to any one of Supplementary Notes 1 to 6, wherein

the storage unit stores the selected virtual object and the virtual point associated with the virtual object in a browsing list when the virtual object is displayed for a predetermined time or longer by the display unit.

### (Supplementary Note 8)

The display apparatus according to any one of Supplementary Notes 1 to 7, further including:

a route calculation unit, wherein

the coordinate information further includes position information of an obstacle existing in the specific area,

the route calculation unit calculates a shortest route from the self-position to the selected virtual point based on the coordinate information, and

the display unit further displays the shortest route.

### (Supplementary Note 9)

The display apparatus according to any one of Supplementary Notes 1 to 8, further including:

a reservation unit, wherein

the reservation unit can reserve at least one of a visit to an exhibitor of advertisement information of the selected virtual object or participation in an event held in the specific area.

### (Supplementary Note 10)

The display apparatus according to any one of Supplementary Notes 1 to 9, further including:

an input unit; and

an extraction unit, wherein

the input unit inputs a freely-selected word,

the extraction unit extracts the virtual object including the input freely-selected word, and

the display unit displays the virtual object, which is existing within the angle of view and extracted, in such a manner that the virtual object is superimposed on the real image.

### (Supplementary Note 11)

The display apparatus according to Supplementary Note 10, wherein

a representative word is set for the virtual object,

the input unit inputs a freely-selected representative word, and

the extraction unit extracts the virtual object including the input representative word.

### (Supplementary Note 12)

The display apparatus according to any one of Supplementary Notes 1 to 11, further including:

a recommendation unit, wherein

the recommendation unit recommends other advertisement information to a user based on the user information, and

the display unit displays a virtual object of the recommended advertisement information.

### (Supplementary Note 13)

The display apparatus according to any one of Supplementary Notes 1 to 12, further including:

a translation unit, wherein

the translation unit can translate a language displayed by the display unit into a freely-selected language.

### (Supplementary Note 14)

The display apparatus according to any one of Supplementary Notes 1 to 13, wherein

a marker unique to each of the specific positions is installed at the specific position,

the imaging unit images the marker and at least one of a real advertising target product or a real advertising target service,

the acquisition unit acquires an explanatory virtual object from the imaged marker,

the explanatory virtual object includes explanatory information on at least one of the real advertising target product or the real advertising target service, and

the display unit displays the explanatory virtual object in a specific part of at least one of the real advertising target product or the real advertising target service.

### (Supplementary Note 15)

The display apparatus according to Supplementary Note 14, wherein

the display unit displays the explanatory virtual object different for each of the attribute information.

### (Supplementary Note 16)

The display apparatus according to any one of Supplementary Notes 1 to 15, which is a visitor's terminal.

### (Supplementary Note 17)

A demand level calculation apparatus, including:

an advertisement information acquisition unit;

a coordinate information generation unit;

a visitor information acquisition unit; and

a demand level calculation unit, wherein

the advertisement information acquisition unit acquires advertisement information on at least one of an advertising target product or an advertising target service in a specific area of a real space,

the coordinate information generation unit generates coordinate information associated with a fiducial marker installed in the specific area,

the coordinate information generation unit maps a virtual point indicating a specific position in the specific area on the coordinate information, and associates the virtual point with the advertisement information,

the visitor information acquisition unit acquires visitor information including attribute information and behavior information of a visitor in the specific area, and

the demand level calculation unit calculates a magnitude of a demand level for the advertisement information based on the advertisement information and the visitor information.

### (Supplementary Note 18)

The demand level calculation apparatus according to Supplementary Note 17, further including:

a reservation information acquisition unit, wherein

the reservation information acquisition unit acquires reservation information indicating a participation reservation from the visitor for an event held in the specific area.

### (Supplementary Note 19)

The demand level calculation apparatus according to Supplementary Note 17 or 18, which is an organizer's terminal.

### (Supplementary Note 20)

An advertisement information generation apparatus, including:

an advertisement information generation unit;

a coordinate information acquisition unit; and

a virtual object generation unit, wherein

the advertisement information generation unit generates advertisement information on at least one of an advertising target product or an advertising target service,

the coordinate information acquisition unit acquires coordinate information associated with a fiducial marker installed in a specific area of a real space,

a virtual point indicating a specific position in the specific area is mapped on the coordinate information,

the virtual object generation unit generates a virtual object associated with the virtual point and the advertisement information,

the virtual object is composed of a main object and a sub object,

the main object is an image object representing contents of the advertisement information, and

the sub object is an object to which text information representing the contents of the advertisement information is added.

### (Supplementary Note 21)

The advertisement information generation apparatus according to Supplementary Note 20, wherein

the virtual object generation unit further sets a representative word for the virtual object.

### (Supplementary Note 22)

The advertisement information generation apparatus according to Supplementary Note 20 or 21, wherein

the virtual object generation unit generates an explanatory virtual sub object different for each attribute information of a user of an apparatus displaying the virtual object, and

the explanatory virtual object is a virtual object that includes explanatory information on at least one of a real advertising target product or a real advertising target service.

### (Supplementary Note 23)

The advertisement information generation apparatus according to any one of Supplementary Notes 20 to 22, further including:

a visitor information acquisition unit; and

a demand level calculation unit, wherein

the visitor information acquisition unit acquires visitor information including attribute information and behavior information of a visitor in the specific area, and

the demand level calculation unit calculates a magnitude of a demand level for the advertisement information based on the advertisement information and the visitor information.

### (Supplementary Note 24)

The advertisement information generation apparatus according to any one of Supplementary Notes 20 to 23, further including:

a reservation information acquisition unit, wherein

the reservation information acquisition unit acquires reservation information indicating a reservation for a visit from the visitor.

### (Supplementary Note 25)

The advertisement information generation apparatus according to any one of Supplementary Notes 20 to 24, further including:

an additional information distribution unit, wherein

the advertisement information generation unit further generates additional information for the advertisement information, and

the additional information distribution unit distributes the additional information to a specific visitor's terminal.

### (Supplementary Note 26)

The advertisement information generation apparatus according to any one of Supplementary Notes 20 to 25, which is an exhibitor's terminal.

### (Supplementary Note 27)

An information sharing apparatus, including:

a visitor management unit;

an organizer management unit; and

an exhibitor management unit, wherein

the visitor management unit includes:
an acquisition unit; and
an output unit, wherein
the acquisition unit acquires coordinate information associated with a fiducial marker installed in a specific area of a real space from the organizer management unit, acquires advertisement information including a virtual object from the exhibitor management unit, and acquires visitor information from a visitor's terminal,
the output unit outputs the visitor information to the organizer management unit and the exhibitor management unit, and outputs an instruction to display a main object of the virtual object existing within an angle of view from a visitor's self-position on the visitor's terminal in such a manner that the main object is superimposed on a relative position on a real image imaged by the visitor's terminal and to display a main object and a sub object of a virtual object selected by the visitor,
the organizer management unit includes:
an acquisition unit; and
an output unit, wherein
the acquisition unit acquires visitor information from the visitor management unit, acquires the advertisement information from the exhibitor management unit, and acquires coordinate information and calculation data obtained by calculating a magnitude of a demand level for the advertisement information from the organizer's terminal,
the output unit outputs the coordinate information to the visitor management unit and the exhibitor management unit, outputs the calculation data to the exhibitor management unit, and outputs the advertisement information to the organizer's terminal, the exhibitor management unit includes:
an acquisition unit; and
an output unit, wherein
the acquisition unit acquires the calculation data and the coordinate information from the organizer management unit, acquires the visitor information from the visitor management unit, and acquires the advertisement information from the exhibitor's terminal,
the output unit outputs the advertisement information to the organizer management unit and the visitor management unit, and outputs the calculation data and the coordinate information to the exhibitor's terminal,

the visitor information includes attribute information and behavior information of a visitor,

a virtual point indicating a specific position in the specific area is mapped on the coordinate information,

the virtual object is associated with the virtual point,

the advertisement information is information on at least one of an advertising target product or an advertising target service,

the main object is an image object representing contents of the advertisement information, and

the sub object is an object to which text information representing the contents of the advertisement information is added.

### (Supplementary Note 28)

The information sharing apparatus according to Supplementary Note 27, wherein

the acquisition unit of the organizer management unit acquires a plurality of pieces of the calculation data from the organizer's terminal, and

the acquisition unit of the exhibitor management unit acquires only specific calculation data from the organizer management unit.

### (Supplementary Note 29)

The information sharing apparatus according to Supplementary Note 27 or 28, wherein
   instead of the organizer management unit acquiring the calculation data from the organizer's terminal,
   in the exhibitor management unit, the output unit further outputs the visitor information to the exhibitor's terminal and outputs an instruction to calculate the magnitude of the demand level for the advertisement information.

### (Supplementary Note 30)

The information sharing apparatus according to any one of Supplementary Notes 27 to 29, wherein

in the visitor management unit, the acquisition unit further acquires reservation information from the visitor's terminal,

in the visitor management unit, the output unit further outputs the reservation information to at least one of the organizer management unit or the exhibitor management unit,

in the organizer management unit, when the reservation information is output from the visitor management unit, the output unit further outputs the reservation information to the organizer's terminal,

in the exhibitor management unit, when the reservation information is output from the visitor management unit, the output unit further outputs the reservation information to the exhibitor's terminal, and

the reservation information is information indicating that at least one of participation in an event held in the specific area or a visit to an exhibitor has been reserved.

### (Supplementary Note 31)

The information sharing apparatus according to Supplementary Note 30, wherein

at least one of the acquisition unit of the organizer management unit or the acquisition unit of the exhibitor management unit to which the reservation information has been output acquires reservation confirmation information indicating whether or not the reservation has been finalized from at least one of the organizer's terminal or the exhibitor's terminal,

at least one of the output unit of the organizer management unit or the output unit of the exhibitor management unit outputs the reservation confirmation information to the visitor management unit, and

the output unit of the visitor management unit outputs the reservation confirmation information to the visitor's terminal.

### (Supplementary Note 32)

The information sharing apparatus according to any one of Supplementary Notes 27 to 31, which is a server of an administrator who administrates information sharing of terminals of an organizer, a visitor, and an exhibitor.

### (Supplementary Note 33)

An event support system, including:

the display apparatus according to any one of Supplementary Notes 1 to 16;

the demand level calculation apparatus according to any one of Supplementary Notes 17 to 19;

the advertisement information generation apparatus according to any one of Supplementary Notes 20 to 26; and

the information sharing apparatus according to any one of Supplementary Notes 27 to 32, wherein

in the information sharing apparatus,

the visitor's terminal is the display apparatus,

the organizer's terminal is the demand level calculation apparatus,

the exhibitor's terminal is the advertisement information generation apparatus, and

the information sharing apparatus can connect the display apparatus, the demand level calculation apparatus, and the advertisement information generation apparatus via a communication network.

### (Supplementary Note 34)

A display method, including the steps of:

storing;

acquiring;

imaging;

self-position specifying;

state detecting;

selecting; and

displaying, wherein

the acquiring acquires coordinate information associated with a fiducial marker installed in a specific area of a real space and a virtual object including advertisement information,

a virtual point indicating a specific position in the specific area is mapped on the coordinate information,

the advertisement information is information on at least one of an advertising target product or an advertising target service,

the virtual object is associated with the virtual point and composed of a main object and a sub object,

the main object is an image object representing contents of the advertisement information,

the sub object is an object to which text information representing the contents of the advertisement information is added,

the storing stores the acquired coordinate information and virtual object,

the imaging images a real image and the fiducial marker,

the self-position specifying specifies a self-position from a distance and an angle from the imaged fiducial marker,

the state detecting detects a distance and an angle of view from the virtual point based on the self-position,

the selecting selects any virtual object existing within an angle of view from the self-position, and

the displaying displays a main object of the virtual object existing within the angle of view from the self-position in such a manner that the main object is superimposed on a relative position on the real image and displays a main object and a sub object of the selected virtual object.

### (Supplementary Note 35)

The display method according to Supplementary Note 34, wherein

the acquiring further acquires user information including attribute information and behavior information, and

the storing stores the user information.

### (Supplementary Note 36)

The display method according to Supplementary Note 34 or 35, wherein

the displaying displays the virtual object existing within an angle of view from the self-position and existing within a freely-determined threshold value from the self-position in such a manner that the virtual object is superimposed on the relative position on the real image.

### (Supplementary Note 37)

The display method according to any one of Supplementary Notes 34 to 36, wherein

the acquiring further acquires additional information for the advertisement information, and

the displaying displays the additional information.

### (Supplementary Note 38)

The display method according to any one of Supplementary Notes 34 to 37, wherein

the imaging continuously images the real image,

the state detecting further detects a movement from the specified self-position and a stop of the movement,

when the movement is detected, the displaying displays the virtual object in such a manner that it is superimposed on the real image before the movement, and

when the stop of the movement is detected, the displaying displays a virtual object existing within an angle of view from the self-position after the movement in such a manner that the virtual object is superimposed on the relative position on the real image after the movement.

### (Supplementary Note 39)

The display method according to any one of Supplementary Notes 34 to 38, wherein

the storing stores the selected virtual object and a virtual point associated with the virtual object in a registration list.

### (Supplementary Note 40)

The display method according to any one of Supplementary Notes 34 to 39, wherein

the storing stores the selected virtual object and the virtual point associated with the virtual object in a browsing list when the virtual object is displayed for a predetermined time or longer by the display unit.

### (Supplementary Note 41)

The display method according to any one of Supplementary Notes 34 to 40, further including the step of:

route calculating, wherein

the coordinate information further includes position information of an obstacle existing in the specific area,

the route calculating calculates a shortest route from the self-position to the selected virtual point based on the coordinate information, and

the displaying further displays the shortest route.

### (Supplementary Note 42)

The display method according to any one of Supplementary Notes 34 to 41, further including the step of:

reserving, wherein

the reserving can reserve at least one of a visit to an exhibitor of advertisement information of the selected virtual object or participation in an event held in the specific area.

### (Supplementary Note 43)

The display method according to any one of Supplementary Notes 34 to 42, further including the steps of:

inputting; and

extracting, wherein

the inputting inputs a freely-selected word,

the extracting extracts the virtual object including the input freely-selected word, and

the displaying displays the virtual object, which is existing within the angle of view and extracted, in such a manner that the virtual object is superimposed on the real image.

### (Supplementary Note 44)

The display method according to Supplementary Note 43, wherein

a representative word is set for the virtual object,

the inputting inputs a freely-selected representative word, and

the extracting extracts the virtual object including the input representative word.

### (Supplementary Note 45)

The display method according to any one of Supplementary Notes 34 to 44, further including the step of:

recommending, wherein

the recommending recommends other advertisement information to a user based on the user information, and

the displaying displays a virtual object of the recommended advertisement information.

### (Supplementary Note 46)

The display method according to any one of Supplementary Notes 34 to 45, further including the step of:

translating, wherein

the translating translates a language displayed by the display unit into a freely-selected language.

### (Supplementary Note 47)

The display method according to any one of Supplementary Notes 34 to 46, wherein

a marker unique to each of the specific positions is installed at the specific position,

the imaging images the marker and at least one of a real advertising target product or a real advertising target service,

the acquiring acquires an explanatory virtual object from the imaged marker,

the explanatory virtual object includes explanatory information on at least one of the real advertising target product or the advertising target service, and

the displaying displays the explanatory virtual object in a specific part of at least one of the real advertising target product or the real advertising target service.

### (Supplementary Note 48)

The display method according to Supplementary Note 47, wherein

the displaying displays the explanatory virtual object different for each of the attribute information.

### (Supplementary Note 49)

The display method according to any one of Supplementary Notes 34 to 48, which is processing in a visitor's terminal.

### (Supplementary Note 50)

A demand level calculation method, comprising the steps of:

advertisement information acquiring;

coordinate information generating;

visitor information acquiring; and

demand level calculating, wherein

the advertisement information acquiring acquires advertisement information on at least one of an advertising target product or an advertising target service in a specific area of a real space,

the coordinate information generating generates coordinate information associated with a fiducial marker installed in the specific area,

the coordinate information generating maps a virtual point indicating a specific position in the specific area on the coordinate information, and associates the virtual point with the advertisement information,

the visitor information acquiring acquires visitor information including attribute information and behavior information of a visitor in the specific area, and

the demand level calculating calculates a magnitude of a demand level for the advertisement information based on the advertisement information and the visitor information.

### (Supplementary Note 51)

The demand level calculation method according to Supplementary Note 50, further including the step of:

reservation information acquiring, wherein

the reservation information acquiring acquires reservation information indicating a participation reservation from the visitor for an event held in the specific area.

### (Supplementary Note 52)

The demand level calculation method according to Supplementary Note 50 or 51, which is processing in the organizer's terminal.

### (Supplementary Note 53)

An advertisement information generation method, including the steps of:

advertisement information generating;

coordinate information acquiring; and

virtual object generating, wherein

the advertisement information generating generates advertisement information on at least one of an advertising target product or an advertising target service,

the coordinate information acquiring acquires coordinate information associated with a fiducial marker installed in a specific area of a real space,

a virtual point indicating a specific position in the specific area is mapped on the coordinate information,

the virtual object generating generates a virtual object associated with the virtual point and the advertisement information,

the virtual object is composed of a main object and a sub object,

the main object is an image object representing contents of the advertisement information, and

the sub object is an object to which text information representing the contents of the advertisement information is added.

### (Supplementary Note 54)

The advertisement information generation method according to Supplementary Note 53, wherein

the virtual object generating further sets a representative word for the virtual object.

### (Supplementary Note 55)

The advertisement information generation method according to Supplementary Note 53 or 54, wherein

the virtual object generating generates an explanatory virtual sub object different for each attribute information of a user of an apparatus displaying the virtual object, and

the explanatory virtual object is a virtual object that includes explanatory information on at least one of a real advertising target product or a real advertising target service.

### (Supplementary Note 56)

The advertisement information generation method according to any one of Supplementary Notes 53 to 55, further including the steps of:

visitor information acquiring; and

demand level calculating, wherein

the visitor information acquiring acquires visitor information including attribute information and behavior information of a visitor in the specific area, and

the demand level calculating calculates a magnitude of a demand level for the advertisement information based on the advertisement information and the visitor information.

### (Supplementary Note 57)

The advertisement information generation method according to any one of Supplementary Notes 53 to 56, further including the step of:

reservation information acquiring, wherein

the reservation information acquiring acquires reservation information indicating a reservation for a visit from the visitor.

### (Supplementary Note 58)

The advertisement information generation method according to any one of Supplementary Notes 53 to 57, further including the step of:

additional information distributing, wherein

the advertisement information generating further generates additional information for the advertisement information, and

the additional information distributing distributes the additional information to a specific visitor's terminal.

### (Supplementary Note 59)

The advertisement information generation method according to any one of Supplementary Notes 53 to 58, which is processing in an exhibitor's terminal.

### (Supplementary Note 60)

An information sharing method, including the steps of:

visitor managing,

organizer managing; and

exhibitor managing, wherein

the visitor managing further includes the steps of:
acquiring; and
outputting, wherein
the acquiring acquires coordinate information associated with a fiducial marker installed in a specific area of a real space from the organizer managing, acquires advertisement information including a virtual object from the exhibitor managing, and acquires visitor information from a visitor's terminal,
the outputting outputs the visitor information to the organizer managing and the exhibitor managing, and outputs an instruction to display a main object of the virtual object existing within an angle of view from a visitor's self-position on the visitor's terminal in such a manner that the main object is superimposed on a relative position on a real image imaged by the visitor's terminal and to display a main object and a sub object of a virtual object selected by the visitor,

the organizer managing further includes the steps of:
acquiring; and
outputting, wherein
the acquiring acquires visitor information from the visitor managing, acquires the advertisement information from the exhibitor managing, and acquires coordinate information and calculation data obtained by calculating a magnitude of a demand level for the advertisement information from the organizer's terminal,
the outputting outputs the coordinate information to the visitor managing and the exhibitor managing, outputs the calculation data to the exhibitor managing, and outputs the advertisement information to the organizer's terminal,

the exhibitor managing further includes the steps of:
acquiring; and
outputting, wherein
the acquiring acquires the calculation data and the coordinate information from the organizer managing, acquires the visitor information from the visitor managing, and acquires the advertisement information from the exhibitor's terminal,

the outputting outputs the advertisement information to the organizer managing and the visitor managing, and outputs the calculation data and the coordinate information to the exhibitor's terminal,

the visitor information includes attribute information and behavior information of a visitor,

a virtual point indicating a specific position in the specific area is mapped on the coordinate information,

the virtual object is associated with the virtual point,

the advertisement information is information on at least one of an advertising target product or an advertising target service,

the main object is an image object representing contents of the advertisement information, and

the sub object is an object to which text information representing the contents of the advertisement information is added.

### (Supplementary Note 61)

The information sharing method according to Supplementary Note 60, wherein

the acquiring of the organizer managing acquires a plurality of pieces of the calculation data from the organizer's terminal, and

the acquiring of the exhibitor managing acquires only specific calculation data from the organizer managing.

### (Supplementary Note 62)

The information sharing method according to Supplementary Note 60 or 61, wherein instead of the organizer managing acquiring the calculation data from the organizer's terminal,

in the exhibitor managing, the outputting further outputs the visitor information to the exhibitor's terminal and outputs an instruction to calculate a magnitude of a demand level for the advertisement information.

### (Supplementary Note 63)

The information sharing method according to any one of Supplementary Notes 60 to 62, wherein

in the visitor managing, the acquiring further acquires reservation information from the visitor's terminal,

in the visitor managing, the outputting further outputs the reservation information to at least one of the organizer managing or the exhibitor managing,

in the organizer managing, when the reservation information is output from the visitor managing, the outputting further outputs the reservation information to the organizer's terminal,

in the exhibitor managing, when the reservation information is output from the visitor managing, the outputting further outputs the reservation information to the exhibitor's terminal, and

the reservation information is information indicating that at least one of participation in an event held in the specific area or a visit to an exhibitor has been reserved.

### (Supplementary Note 64)

The information sharing method according to Supplementary Note 63, wherein

at least one of the acquiring of the organizer managing or the acquiring of the exhibitor managing to which the reservation information has been output acquires reservation confirmation information indicating whether or not the reservation has been finalized from at least one of the organizer's terminal or the exhibitor's terminal,

at least one of the outputting of the organizer managing or the outputting of the exhibitor managing outputs the reservation confirmation information to the visitor managing, and

the outputting of the visitor managing outputs the reservation confirmation information to the visitor's terminal.

### (Supplementary Note 65)

The information sharing method according to any one of Supplementary Notes 60 to 64, which is processing in a server of an administrator who administrates information sharing of terminals of an organizer, a visitor, and an exhibitor.

### (Supplementary Note 66)

An event support system production method, including:

the display apparatus according to any one of Supplementary Notes 1 to 16;

the demand level calculation apparatus according to any one of Supplementary Notes 17 to 19;

the advertisement information generation apparatus according to any one of Supplementary Notes 20 to 26; and

the information sharing apparatus according to any one of Supplementary Notes 27 to 32, wherein

in the information sharing apparatus,

the visitor's terminal is the display apparatus,

the organizer's terminal is the demand level calculation apparatus,

the exhibitor's terminal is the advertisement information generation apparatus, and

the information sharing apparatus connects the display apparatus, the demand level calculation apparatus, and the advertisement information generation apparatus via a communication network.

### (Supplementary Note 67)

A program for a computer to execute the method according to any one of Supplementary Notes 34 to 66.

### (Supplementary Note 68)

A distribution server for distributing the program according to Supplementary Note 67.

### (Supplementary Note 69)

A distribution server for distributing a program for a computer to execute the method according to any one of Supplementary Notes 60 to 65 to the information sharing apparatus according to any one of Supplementary Notes 27 to 32, wherein

via the information sharing apparatus,

the server distributes a program for a computer to execute the method according to any one of Supplementary Notes 34 to 49 to the display apparatus according to any one of Supplementary Notes 1 to 16,

the server distributes a program for a computer to execute the method according to any one of Supplementary Notes 50 to 52 to the demand level calculation apparatus according to any one of Supplementary Notes 17 to 19, and

the server distributes a program for a computer to execute the method according to any one of Supplementary Notes 53 to 59 to the advertisement information generation apparatus according to any one of Supplementary Notes 20 to 26.

### (Supplementary Note 70)

A computer readable recording medium with the program according to Supplementary Note 67.

### INDUSTRIAL APPLICABILITY

According to the present invention, it is possible to promote products and the like at low cost and easily. For this reason, the present invention is useful in various fields to which AR is applicable.

### REFERENCE SIGNS LIST

1: fiducial marker
2: main object
3: sub object
4: terminal
5: guiding virtual object
6: visitor
7: communication network
10: display apparatus
11: storage unit
12: acquisition unit
13: imaging unit
14: self-position specifying unit
15 state detecting unit
16: selection unit
17: display unit
18: route calculation unit
19: reservation unit
20: demand level calculation apparatus
21: advertisement information acquisition unit
22: coordinate information generation unit
23: visitor information acquisition unit
24: demand level calculation unit
30: advertisement information generation apparatus
31: advertisement information generation unit
32: coordinate information acquisition unit
33: virtual object generation unit
40: information sharing apparatus
41: visitor management unit
411: acquisition unit
412: output unit
42: organizer management unit
421: acquisition unit
422: output unit
43: exhibitor management unit
431: acquisition unit
432: output unit
50: event support system
101: central processing device
102: memory
103: bus
104: storage device
105: input device
106: display device
107: communication device

What is claimed is:

1. An apparatus for displaying, comprising at least one processor configured to:
acquires acquire coordinate information associated with a fiducial marker installed in a specific area of a real space and a virtual object including advertisement information, wherein
a virtual point indicating a specific position in the specific area is mapped on the coordinate information,
the advertisement information is information on at least one of an advertising target product or an advertising target service,
the virtual object is associated with the virtual point and composed of a main object and a sub object,
the main object is an image object representing contents of the advertisement information,
the sub object is an object to which text information representing the contents of the advertisement information is added, and
the processor is configured to:
store the acquired coordinate information and virtual object,
image a real image and the fiducial marker,
specify a self-position from a distance and an angle from the imaged fiducial marker,
detect a distance and an angle of view from the virtual point based on the self-position,
select any virtual object existing within an angle of view from the self-position, and
display a main object of the virtual object existing within the angle of view from the self-position in such a manner that the main object is superimposed on a relative position on the real image and displays a main object and a sub object of the selected virtual object.

2. The apparatus according to claim 1, wherein
the processor is configured to:
acquire user information comprising attribute information and behavior information, and
store the user information.

3. The apparatus according to claim 1, wherein
the processor is configured to:
display the virtual object existing within an angle of view from the self-position and existing within a freely-determined threshold value from the self-position in such a manner that the virtual object is superimposed on the relative position on the real image.

4. The apparatus according to claim 1, wherein
the processor is configured to:
acquires acquire additional information for the advertisement information, and
display the additional information.

5. The apparatus according to claim 1, wherein
the processor is configured to:
continuously image the real image,
further detect a movement from the specified self-position and a stop of the movement, wherein
when the movement is detected, the processor displays the virtual object in such a manner that it is superimposed on the real image before the movement, and
when the stop of the movement is detected, display the processor a virtual object existing within an angle of view from the self-position after the movement in such a manner that the virtual object is superimposed on the relative position on the real image after the movement.

6. The apparatus according to claim 1, wherein
the processor is configured to store the selected virtual object and a virtual point associated with the virtual object in a registration list.

7. The apparatus according to claim 1, wherein
the processor is configured to: store the selected virtual object and the virtual point associated with the virtual object in a browsing list when the virtual object is displayed for a predetermined time or longer by the processor.

8. The apparatus according to of claim 1,
wherein
the coordinate information further includes position information of an obstacle existing in the specific area, and
the processor is configured to:
calculate a shortest route from the self-position to the selected virtual point based on the coordinate information, and
further display the shortest route.

9. The apparatus according to claim 1
the processor is configured to be able to reserve at least one of a visit to an exhibitor of advertisement information of the selected virtual object or participation in an event held in the specific area.

10. The apparatus according to claim 1,
the processor is configured to:
input a freely-selected word,
extract the virtual object comprising the input freely-selected word, and
display the virtual object, which is existing within the angle of view and extracted, in such a manner that the virtual object is superimposed on the real image.

11. The apparatus according to claim 10, wherein
a representative word is set for the virtual object, and
the processor is configured to:
input a freely-selected representative word, and
extract the virtual object comprising the input representative word.

12. The apparatus according to claim 1,
wherein
the processor is configured to:
recommend other advertisement information to a user based on the user information, and
display a virtual object of the recommended advertisement information.

13. The apparatus according to claim 1
the processor is configured to be able to translate a language displayed by the processor into a freely-selected language.

14. The apparatus according to claim 1, wherein
a marker unique to each of the specific positions is installed at the specific position, and
the processor is configured to:
image the marker and at least one of a real advertising target product or a real advertising target service,
acquire an explanatory virtual object from the imaged marker, wherein
the explanatory virtual object includes explanatory information on at least one of the real advertising target product or the real advertising target service, and
the processor is configured to
display the explanatory virtual object in a specific part of at least one of the real advertising target product or the real advertising target service.

15. The apparatus according to claim 14, wherein
the processor is configured to display the explanatory virtual object different for each of the attribute information.

16. The apparatus according to claim 1, which is a visitor's terminal.

17. A system for event support, comprising the apparatus according to claim 1 and at least one processor configured to:
have the apparatus for display according to claim 1:
have an apparatus for demand level calculation;
have an apparatus for advertisement information generation; and
have an apparatus for information sharing, wherein
the apparatus for demand level calculation calculate a magnitude of the demand level for the advertisement information based on the advertisement information and the user information;
the apparatus for advertisement information generation generates the advertisement information and the virtual object,
the apparatus for information sharing administrates information sharing among three terminals of a visitor, an organizer, and an exhibitor, wherein
the visitor's terminal is the apparatus according to claim 1,
the organizer's terminal is the apparatus for demand level calculation,
the exhibitor's terminal is the apparatus for advertisement information generation, and
the apparatus for information sharing can connect the apparatus for display, the demand apparatus for demand level calculation, and the apparatus for advertisement information generation via a communication network.

18. A computer-implemented method for display, comprising:
acquiring coordinate information associated with a fiducial marker installed in a specific area of a real space and a virtual object comprising advertisement information,
a virtual point indicating a specific position in the specific area is mapped on the coordinate information, wherein
the advertisement information is information on at least one of an advertising target product or an advertising target service,
the virtual object is associated with the virtual point and composed of a main object and a sub object,
the main object is an image object representing contents of the advertisement information,
the sub object is an object to which text information representing the contents of the advertisement information is added, and
storing the acquired coordinate information and virtual object,
imaging a real image and the fiducial marker,
specifying a self-position from a distance and an angle from the imaged fiducial marker,
detecting a distance and an angle of view from the virtual point based on the self-position,
selecting any virtual object existing within an angle of view from the self-position, and
displaying a main object of the virtual object existing within the angle of view from the self-position in such a manner that the main object is superimposed on a relative position on the real image and displays a main object and a sub object of the selected virtual object.

19-37. (canceled)

38. A non-transitory computer readable recording medium with the program, wherein
the program causes a computer to execute a method for display,
the method comprising:
acquiring coordinate information associated with a fiducial marker installed in a specific area of a real space and a virtual object comprising advertisement information,
a virtual point indicating a specific position in the specific area is mapped on the coordinate information, wherein
the advertisement information is information on at least one of an advertising target product or an advertising target service,
the virtual object is associated with the virtual point and composed of a main object and a sub object,
the main object is an image object representing contents of the advertisement information,
the sub object is an object to which text information representing the contents of the advertisement information is added, and
storing the acquired coordinate information and virtual object,
imaging a real image and the fiducial marker,
specifying a self-position from a distance and an angle from the imaged fiducial marker,
detecting a distance and an angle of view from the virtual point based on the self-position,
selecting any virtual object existing within an angle of view from the self-position, and
displaying a main object of the virtual object existing within the angle of view from the self-position in such a manner that the main object is superimposed on a relative position on the real image and displays a main object and a sub object of the selected virtual object.
